(19) United States
(12) Patent Application Publication
(10) Pub. No.: US 2008/0198187 A1
(43) Pub. Date: Aug. 21, 2008

(54) LIQUID RESIDUAL AMOUNT DETECTION APPARATUS FOR LIQUID CONTAINER

(76) Inventors: Yuji Aoki, Matsumoto-shi (JP); Hitotoshi Kimura, Matsumoto-shi (JP); Junhua Zhang, Shiojiri-shi (JP); Minoru Usui, Shiojiri-shi (JP)

Correspondence Address: STROOCK & STROOCK & LAVAN LLP, 180 MAIDEN LANE, NEW YORK, NY, 10038, US

(21) Appl. No.: 11/560,492

(22) Filed: May 15, 2007

(30) Foreign Application Priority Data
Nov. 18, 2005 (JP) P2005-334941
Nov. 18, 2005 (JP) P2005-334942
Jan. 16, 2006 (JP) P2006-008043

(51) Int. Cl. B41J 2/195; G01F 23/00

(52) U.S. Cl. 347/7; 73/291

(57) ABSTRACT

A liquid residual amount detection apparatus for a liquid container, includes: a sensor chamber that has a liquid supply port introducing liquid to be delivered from a liquid containing portion, and supplies the liquid to an external liquid consuming apparatus; a diaphragm that defines a part of the sensor chamber and is movable in response to a liquid containing amount in the sensor chamber; a pressure receiving plate that is attached to the diaphragm; a recess portion that is connected to the sensor chamber and is closed by the pressure receiving plate when the liquid containing amount in the sensor chamber becomes a predetermined amount or less; a piezoelectric element that applies vibration to at least a part of the recess portion so as to detect a free vibration state according to the applied vibration; a detection portion that detects an amplitude value or a frequency of a residual vibration waveform of a counter electromotive force by the free vibration state detected by the piezoelectric element; and a calculation portion that calculates a liquid residual amount in the liquid container on the basis of the amplitude value or the frequency of the residual vibration waveform detected by the detection portion.

### BACKGROUND

1. Technical Field

The present invention relates to a liquid residual amount detection apparatus for a liquid container, and in particular, a liquid residual amount detection apparatus for a liquid container that is applied to a liquid ejecting apparatus, such as an ink jet recording apparatus or the like.

2. Related Art

A liquid ejecting head of a printing apparatus, a microdispenser, or a commercial recording apparatus that requires ultrahigh printing quality receives a liquid from a liquid container. However, if the liquid ejecting head operates in a state where the liquid is not supplied, idle printing occurs, and thus the liquid ejecting head is likely to be damaged. In order to prevent this problem, it is necessary to monitor a liquid residual amount in the container.

In case of a recording apparatus, there have been various methods of detecting an ink residual amount of an ink cartridge serving as the liquid container. For example, there is known a technology that checks the ink decrease by moving a flat plate through urging of a spring to be then distant from a detection mechanism when the residual amount of a liquid is lowered to a defined value or less, and by stopping the output of a detection signal from the detection mechanism (for example, Patent Document 1).

Further, there is suggested a method that detects an ink residual amount in an ink pack by attaching a piezoelectric sensor and a pressure receiving plate to a flexible ink pack of a liquid container such that the flexible ink pack is interposed between the piezoelectric sensor and the pressure receiving plate, applying a charging/discharging waveform signal to the piezoelectric sensor, and detecting a vibration amplitude at that time (Patent Document 2).

Patent Document 1: JP-A-2004-306604

Patent Document 2: JP-A-2004-136670

The detection mechanism disclosed in Patent Document 1 can detect the ink decrease by spacing of the flat plate so as to detect a time at which ink decreases. However, in this case, a mechanical switch mechanism is complex, a shape becomes large, and it is easily broken down. Further, it is difficult to distinguish these problems due to ink exhaustion or a sensor trouble. Accordingly, in order to reliably grasp the ink decrease by a simple unit, it is desirable to directly detect ink itself.

There is suggested a method that directly detects presence/absence of ink in the sensor chamber by applying vibration to the sensor chamber in the detection mechanism and detecting a waveform of residual vibration by a piezoelectric element. In this case, however, since the amplitude of the residual vibration is extremely small, it is difficult to accurately distinguish a difference in waveform of the residual vibration by presence/absence of the liquid.

In the structure of Patent Document 2, a piezoelectric sensor unit is directly attached to the ink pack of the liquid container. However, the deformation of the ink pack is not necessarily uniform due to flexibility of the ink pack, and the output of the piezoelectric sensor does not accurately follow the ink decrease.

### SUMMARY

An advantage of some aspects of the invention is to provide a liquid residual amount detection apparatus for a liquid container that has a diaphragm and a piezoelectric element provided in a liquid detection chamber connected to a liquid containing portion and detects an actual liquid residual amount and liquid exhaustion from an accurate change in volume of the liquid detection chamber by the diaphragm and a change (amplitude or frequency) in vibration wave of a piezoelectric element accordingly.

The advantage can be attained as at least one of the following aspects:

A first aspect of the invention provides a liquid residual amount detection apparatus for a liquid container, comprising:

a sensor chamber that has a liquid supply port introducing liquid to be delivered from a liquid containing portion, and supplies the liquid to an external liquid consuming apparatus; a diaphragm that is defines a part of the sensor chamber and is movable in response to a liquid containing amount in the sensor chamber; a pressure receiving plate that is attached to the diaphragm; a recess portion that is connected to the sensor chamber and is closed by the pressure receiving plate when the liquid containing amount in the sensor chamber becomes a predetermined amount or less; a piezoelectric element that applies vibration to at least a part of the recess portion so as to detect a free vibration state according to the applied vibration; a detection portion that detects an amplitude value or a frequency of a residual vibration waveform of a counter electromotive force by the free vibration state detected by the piezoelectric element; and a calculation portion that calculates a liquid residual amount in the liquid container on the basis of the amplitude value or the frequency of the residual vibration waveform detected by the detection portion.

A second aspect of the invention provides a liquid residual amount detection apparatus for a liquid container, comprising: a sensor chamber that has a liquid supply port introducing liquid to be delivered from a liquid containing portion and supplies the liquid to an external liquid consuming apparatus, a diaphragm that defines a part of the sensor chamber and is movable in response to a liquid containing amount in the sensor chamber; a recess portion that is connected to the sensor chamber and is displaced together with the diaphragm so as to be closed by a bottom inner surface of the sensor chamber when the liquid containing amount in the sensor chamber becomes a predetermined amount or less; a piezoelectric element that is attached to the diaphragm and applies vibration to at least a part of the recess portion so as to detect a free vibration state according to the applied vibration; a detection portion that detects an amplitude value or frequency of a residual vibration waveform of a counter electromotive force by the free vibration state detected by the piezoelectric element; and a calculation portion that calculates a liquid residual amount in the liquid container on the basis of the amplitude value or the frequency of the residual vibration waveform detected by the detection portion.

According to the first and second aspects of the invention, the amplitude or the frequency of the free vibration of the vibrating plate is detected by causing the piezoelectric vibrating element to apply the vibration to the liquid through the vibrating plate, and the liquid residual amount in the sensor chamber is specifically calculated by the calculation portion from the amplitude or the frequency. Therefore, it is possible to know an actual residual amount until lack of ink.

The liquid residual amount detection apparatus having the configuration may further include a pressure adjusting spring that is attached so as to cause the diaphragm to be displaced at a predetermined pressure.

Accordingly, as for a characteristic curve showing the relationship between a distance from a support base of the piezoelectric vibrating element to the pressure receiving plate (or from the support base of the piezoelectric vibrating plate to the bottom inner surface of the sensor chamber) and the amplitude of the residual vibration waveform, the characteristics can be changed by changing an urging force of a pressure adjusting spring, and thus a desired characteristic curve can be obtained.

The diaphragm may be a flexible film.

Accordingly, airtightness in the diaphragm can be increased, gas can be prevented from entering to the liquid in the sensor chamber, and a high degree of deaeration can be maintained.

The diaphragm may be a thin plate member on which aluminum is laminated.

Accordingly, more reliably, airtightness can be increased, gas can be prevented from entering the liquid in the sensor chamber, and a high degree of deaeration can be maintained.

The liquid may be ink. Accordingly, the invention can be applied to a liquid ejecting apparatus, such as an inkjet recording apparatus or the like.

According to the first and second aspects of the invention, the amplitude or the frequency of the free vibration of the vibrating plate is detected by causing the piezoelectric vibrating element to apply the vibration to the liquid through the vibrating plate, and the liquid residual amount in the sensor chamber is calculated by the calculation portion from the amplitude or the frequency. Therefore, it is possible to know the actual residual amount until lack of ink. In particular, according to the first and second aspects of the invention, the piezoelectric vibrating element or the pressure receiving plate that operates in cooperation with the piezoelectric vibrating element is supported by the flexible diaphragm. Therefore, it is possible to follow a change in volume of the sensor chamber by the liquid decrease and to amplify the free vibration of the vibrating plate to a higher level by the small number of parts. Further, it is possible to reliably detect the residual amount or presence/absence of the liquid (ink) in the sensor chamber.

A third aspect of the invention provides a liquid detection apparatus comprising: a pressure sensor chamber that has a liquid inlet port connected to a liquid containing portion storing liquid and a liquid outlet port connected to a supply destination of the liquid; a liquid detecting unit that has a vibrating plate, a cavity being formed on a side of the pressure sensor chamber of the vibrating plate; a piezoelectric element that is attached to the vibrating plate of the liquid detecting unit and applies vibration to the vibrating plate so as to detect a free vibration state according to the vibration; and a flexible diaphragm that displaceably supports the liquid detecting unit according to a liquid amount in the pressure sensor chamber and forms a part of the pressure sensor chamber together with the liquid detecting unit.

According to the liquid detection apparatus having the above configuration, presence/absence of the liquid in the pressure sensor chamber can be accurately detected by causing the piezoelectric element to apply the vibration to a part of the pressure sensor chamber through the vibrating plate and monitoring a change in amplitude of the free vibration of the vibrating plate (presence/absence of the amplitude or the like) or a change in frequency of the free vibration of the vibrating plate.

In particular, since the liquid detecting unit having the vibrating plate is supported by the flexible diaphragm, it is possible to amplify the free vibration of the vibrating plate to a higher level by the small number of parts, and to reliably detect presence/absence of the liquid in the liquid detecting unit.

The liquid detection apparatus having the above configuration may further include an urging member that urges the liquid detecting unit toward a wall surface forming the pressure sensor chamber. In this case, the liquid detecting unit may come into contact with the wall surface by an urging force of the urging member according to a decrease of the liquid amount in the pressure sensor chamber so as to close the cavity.

Accordingly, when the liquid amount in the liquid detecting unit decreases, the liquid detecting unit reliably comes into contact with the wall surface of the pressure sensor chamber by the urging member so as to close the cavity.

That is, when the liquid in the pressure sensor chamber decreases, presence/absence of the liquid in the pressure sensor chamber can be more reliably detected by reliably changing a vibration reaction region by the piezoelectric element.

In the liquid detection apparatus having the above configuration, the urging member may have an urging force weaker than a liquid pressure of the liquid flowing into the pressure sensor chamber.

Accordingly, the liquid detecting unit can be reliably displaced according to a decrease of the liquid pressure in the pressure sensor chamber, and an erroneous operation, for example, the displacement of the liquid detecting unit regardless of the presence of the liquid in the pressure sensor chamber can be eliminated. As a result, the liquid can be detected with high precision.

The diaphragm may be formed of an aluminum-laminated film on which aluminum is laminated.

Accordingly, airtightness in the diaphragm can be increased, gas can be prevented from entering the liquid in the pressure sensor chamber, and a high degree of deaeration can be maintained.

A fourth aspect of the invention provides a liquid container includes a liquid containing portion that is pressurized by a pressure unit so as to deliver liquid, a liquid supply port that is connected to the liquid containing portion so as to supply the liquid to the outside, and the above-described liquid detection apparatus that is provided between the liquid containing portion and the liquid supply port.

According to the liquid container having the above configuration, in a state where the liquid container is mounted on an external liquid consuming apparatus, and the liquid containing portion is pressurized by the pressure unit, presence/absence of the liquid in the liquid containing portion can be reliably detected by the liquid detection apparatus provided between the liquid containing portion and the liquid supply port.

Accordingly, for example, when the invention is applied to a liquid container that supplies a liquid, such as ink or the like, to a liquid ejecting head of a printing apparatus, a microdispenser, or a commercial recording apparatus that requires ultrahigh printing quality, so-called idle printing, that is, a phenomenon that, when the apparatus operates in a state where the liquid container is empty and the liquid is not supplied, can be eliminated, and thus the ejecting head can be prevented from being damaged due to idle printing.

According to the liquid detection apparatus of the third aspect of the invention, presence/absence of the liquid in the pressure sensor chamber can be accurately detected by causing the piezoelectric element to apply the vibration to apart of the pressure sensor chamber through the vibrating plate and monitoring a change in amplitude of the free vibration of the vibrating plate (presence/absence of the amplitude or the like) or a change in frequency of the free vibration of the vibrating plate. Further, since the liquid detecting unit having the vibrating plate is supported by the flexible diaphragm, it is possible to amplify the free vibration of the vibrating plate to a higher level by the small number of parts, and to reliably detect presence/absence of the liquid in the liquid detecting unit.

According to the liquid container having the liquid detection apparatus of the fourth aspect of the invention, for example, when the invention is applied to a liquid container that supplies a liquid, such as ink or the like, to a liquid ejecting head of a printing apparatus, a microdispenser, or a commercial recording apparatus that requires ultrahigh printing quality, so-called idle printing, that is, a phenomenon that, when the apparatus operates in a state where the liquid container is empty and the liquid is not supplied, can be eliminated, and thus the ejecting head can be prevented from being damaged due to idle printing.

A fifth aspect of the invention provides a liquid detection apparatus comprising: a pressure sensor chamber that has a liquid inlet port connected to an external liquid containing portion storing liquid and a liquid outlet port connected to a supply destination of the liquid; a liquid detecting unit that has a vibrating plate, a cavity being formed on a side of the pressure sensor chamber of the vibrating plate; a piezoelectric element that is attached to the vibrating plate of the liquid detecting unit and applies vibration to the vibrating plate so as to detect a free vibration state according to the vibration; and a vibration absorption member that is formed of an elastic material, wherein the liquid detecting unit and the vibration absorption member are disposed to be relatively displaced in a direction close to each other or distant from each other according to a liquid amount in the pressure sensor chamber.

According to the liquid detection apparatus having the above configuration, the state of the liquid in the pressure sensor chamber can be accurately detected by causing the piezoelectric element to apply the vibration to a part of the pressure sensor chamber through the vibrating plate and monitoring a change in amplitude of the free vibration of the vibrating plate (presence/absence of the amplitude or the like) or a change in frequency of the free vibration of the vibrating plate.

In particular, since the liquid detecting unit and the vibration absorption member can be relatively displaced in the direction close to each other or distant from each other according to the liquid amount in the pressure sensor chamber, it is possible to significantly change an output waveform of the piezoelectric element in association with the change of the liquid amount in the pressure sensor chamber by a vibration absorption effect of the vibration absorption member, and to reliably detect the state of the liquid in the pressure sensor chamber.

In the liquid detection apparatus having the above configuration, as the liquid amount in the pressure sensor chamber decreases, the decrease of the liquid amount in the pressure sensor chamber may be detected on the basis of an output signal from the piezoelectric element when the vibration absorption member comes into contact with the liquid detecting unit.

That is, when the vibration absorption member comes into contact with the liquid detecting unit, the vibration of the liquid can be reliably absorbed by the vibration absorption member. Further, the decrease state of the liquid amount in the pressure sensor chamber can be reliably detected.

In the liquid detection apparatus having the above configuration, as the liquid amount in the pressure sensor chamber decreases, the decrease of the liquid amount in the pressure sensor chamber may be detected on the basis of an output signal from the piezoelectric element when the vibration absorption member is close to the liquid detecting unit.

That is, when the vibration absorption member is close to the liquid detecting unit, the vibration of the liquid can be reliably absorbed by the vibration absorption member. Further, the decrease state of the liquid amount in the pressure sensor chamber can be reliably detected.

In the liquid detection apparatus having the above configuration, the vibration absorption member may be supported by a flexible film that forms a portion of the pressure sensor chamber, and, when the film is deformed by the liquid amount in the pressure sensor chamber, the vibration absorption member may be displaced in a direction close to or distant from the liquid detecting unit.

Accordingly, the vibration absorption member can be displaced well in the direction close to or distant from the liquid detecting unit by the film that is deformed according to the change of the liquid amount of the pressure sensor chamber. Further, the state of the liquid in the pressure sensor chamber can be reliably detected.

A sixth aspect of the invention provides a liquid container including a liquid containing portion that is pressurized by a pressure unit so as to deliver a liquid, a liquid supply port that is connected to the liquid containing portion so as to supply the liquid to the outside, and the above-described liquid detection apparatus that is provided between the liquid containing portion and the liquid supply port.

According to the liquid container having the above configuration, in a state where the liquid container is mounted on an external liquid consuming apparatus, and the liquid containing portion is pressurized by the pressure unit, the state of the liquid in the liquid containing portion can be reliably detected by the liquid detection apparatus provided between the liquid containing portion and the liquid supply port.

Accordingly, for example, when the invention is applied to a liquid container that supplies a liquid, such as ink or the like, to a liquid ejecting head of a printing apparatus, a midrodispenser, or a commercial recording apparatus that requires ultrahigh printing quality, so-called idle printing, that is, a phenomenon that, when the apparatus operates in a state where the liquid container is empty and the liquid is not supplied, can be eliminated, and thus the ejecting head can be prevented from being damaged due to idle printing.

According to the liquid detection apparatus of the fifth aspect of the invention, the state of the liquid in the pressure sensor chamber can be accurately detected by causing the piezoelectric element to apply the vibration to apart of the pressure sensor chamber and monitoring a change in amplitude of the free vibration of the vibrating plate (presence/absence of the amplitude or the like) or a change in frequency of the free vibration of the vibrating plate.

In particular, since the liquid detecting unit and the vibration absorption member can be relatively displaced in the direction close to each other or distant from each other according to the liquid amount in the pressure sensor chamber, it is possible to significantly change an output waveform of the piezoelectric element in association with the change of the liquid amount in the pressure sensor chamber by a vibration absorption effect of the vibration absorption member, and to reliably detect the state of the liquid in the pressure sensor chamber.

According to the liquid container having the liquid detection apparatus of the sixth aspect of the invention, for example, when the invention is applied to a liquid container that supplies a liquid, such as ink or the like, to a liquid ejecting head of a printing apparatus, a microdispenser, or a commercial recording apparatus that requires ultrahigh printing quality, so-called idle printing, that is, a phenomenon that, when the apparatus operates in a state where the liquid container is empty and the liquid is not supplied, can be eliminated, and thus the ejecting head can be prevented from being damaged due to idle printing.

The present disclosure relates to the subject matter contained in Japanese Patent application Nos. 2005-334941 filed on Nov. 18, 2005, 2005-334942 filed on Nov. 18, 2005, and 2006-008043 filed on Jan. 16, 2006, which are expressly incorporated herein by reference in its entirety.

### BRIEF DESCRIPTION OF THE DRAWINGS

FIG. 1 is a cross-sectional view showing an example of a liquid container having a liquid residual amount detection apparatus of the invention.

FIG. 2 is a cross-sectional view showing another example of a liquid container having a liquid residual amount detection apparatus of the invention.

FIG. 3 is an enlarged cross-sectional view showing the structure of a liquid residual amount detection apparatus according to a first embodiment of the invention.

FIG. 4 is an enlarged cross-sectional view showing the structure of a liquid residual amount detection apparatus according to a second embodiment of the invention.

FIGS. 5A and 5B are diagrams showing a driving signal to be applied to a piezoelectric vibrating element, and an output signal of the piezoelectric vibrating element in a state where a liquid of a liquid containing portion is sufficient.

FIG. 6 is a diagram showing the relationship between an ink residual amount of a liquid containing portion and a pressure in a sensor chamber.

FIG. 7 is a diagram showing the relationship between a height of a sensor chamber and an amplitude of a residual vibration waveform by a piezoelectric vibrating element according to an embodiment of the invention.

FIG. 8 is a diagram showing the relationship between an ink residual amount of a liquid containing portion and an amplitude of a residual vibration waveform by a piezoelectric vibrating element.

FIG. 9 is a cross-sectional view showing the structure of a liquid detection apparatus according to a third aspect of the invention.

FIG. 10A is a diagram showing a signal that is supplied to a piezoelectric element, FIG. 10B is a diagram showing an output signal of a piezoelectric element when an ink amount is sufficient, and FIG. 10C is a diagram showing an output signal of a piezoelectric element when an ink amount decreases.

FIG. 11 is a cross-sectional view showing a state of a liquid detection apparatus when an ink amount is sufficient.

FIG. 12 is a cross-sectional view showing a state of a liquid detection apparatus when an ink amount decreases.

FIG. 13 is a diagram showing the relationship between an ink amount of a pressure sensor chamber and an amplitude of a vibrating plate.

FIG. 14 is a cross-sectional view showing an embodiment of a liquid container having a liquid detection apparatus of the invention according to a fourth embodiment of the invention.

FIG. 15 is a cross-sectional view showing the structure of a liquid detection apparatus.

FIG. 16A is a diagram showing a signal that is supplied to a piezoelectric element, FIG. 16B is a diagram showing an output signal of a piezoelectric element when an ink amount is sufficient, and FIG. 16C is a diagram showing an output signal of a piezoelectric element when an ink amount decreases.

FIG. 17 is a cross-sectional view showing a state of a liquid detection apparatus when an ink amount is sufficient.

FIG. 18 is a cross-sectional view showing a state of a liquid detection apparatus when an ink amount decreases.

FIG. 19 is a diagram showing the relationship between an ink amount of a pressure sensor chamber and a distance of a vibration absorption member to a piezoelectric sensor.

FIG. 20 is a cross-sectional view showing the structure of another liquid detection apparatus.

### DESCRIPTION OF EXEMPLARY EMBODIMENTS

Hereinafter, embodiments of a liquid residual amount detection apparatus and a liquid container having the same according to the invention will be described with reference to the drawings. Moreover, in the following embodiments, the descriptions will be given by way of a closed ink cartridge that is mounted on a recording apparatus, as a liquid container.

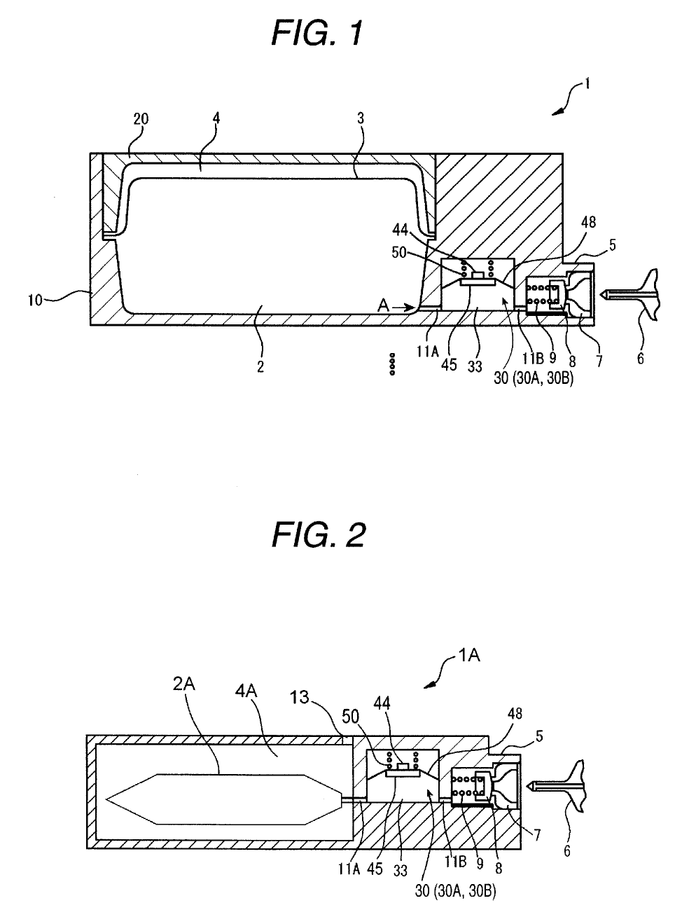

FIG. 1 is a cross-sectional view showing an example of a liquid container having a liquid residual amount detection apparatus of the invention. As shown in FIG. 1, an ink cartridge (liquid container) 1 is mounted on the recording apparatus, and includes a cartridge case having a first case 10 and a second case 20. The first case 10 and the second case 20 have a box shape with a bottom and are united so as to form a half shell. In the first case 10, an opening is formed so as to form a liquid containing portion 2 that contains a liquid, such as ink or the like. The opening is covered with a flexible film body 3 formed of a resin film or the like. The flexible film body 3 is bonded to the periphery of the first case 10 through thermal welding.

Meanwhile, on the other side of the flexible film body 3, the periphery of the second case 20 is pressed into contact with a thermally welded portion of the flexible film body 3, such that an airtight space is formed between the second case 20 and the flexible film body 3. The airtight space becomes a pressure region 4 into which a pressurized fluid (pressurized air) is introduced by a pressurized fluid introduction port (not shown) from the outside. If the pressurized fluid is introduced into the pressure region 4, the flexible film body 3 is pressurized, and the liquid in the first case 10 is pressurized in a direction (a direction of an arrow A) in which the liquid is discharged to the outside.

On an outer surface of the first case 10, a liquid supply port 5 is formed so as to be connected to a liquid supply path of the recording apparatus. In the liquid supply port 5, a packing 7 that has an opening to be brought into elastic contact with a periphery of a liquid introduction needle 6 connected to a recording head of the recording apparatus, a valve body 8 that comes into contact with an end surface of the packing 7 so as to seal the opening of the packing 7, and a spring 9, such as a coil spring or the like, that urges the valve body 8 toward the packing 7 are provided.

In the liquid supply port 5, a valve constantly keeps a closed state by the spring 9 in a state where the connection to the recording apparatus is not made. Further, when the connection to the recording apparatus is made, the valve body 8 is pressed by the liquid introduction needle 6 in a direction in which a valve is opened, such that the valve is opened. Further, the liquid supply port 5 and the liquid containing portion 2 are connected to each other through a liquid inlet port 11A and a liquid outlet port 11B. A liquid residual amount detection apparatus 30 is provided between the liquid inlet port 11A and the liquid outlet port 11B.

The liquid containing portion 2 may have the cases and the flexible film body shown in FIG. 1 or may have an ink pack that is formed by adhering flexible resin films, such as aluminum-laminated films or the like, and then is accommodated in an ink cartridge. FIG. 2 is a cross-sectional view showing an example of this configuration.

FIG. 2 is a cross-sectional view showing another example of a liquid container having a liquid residual amount detection apparatus of the invention. A liquid container 1A shown in FIG. 2 has, in a pressure chamber 4A to be pressurized by a pressure unit (not shown), an ink pack (liquid containing portion) 2A that discharges ink stored therein by a pressure by the pressure chamber 4A. As a pressure method, for example, there is a method of supplying a pressurized fluid (pressurized air) from a pressure port 13 provided at a part of a wall surface of the pressure chamber 4A.

Moreover, other parts are the same as those of the liquid container 1 shown in FIG. 1. The same parts are represented by the same reference numerals, and the detailed descriptions thereof will be omitted.

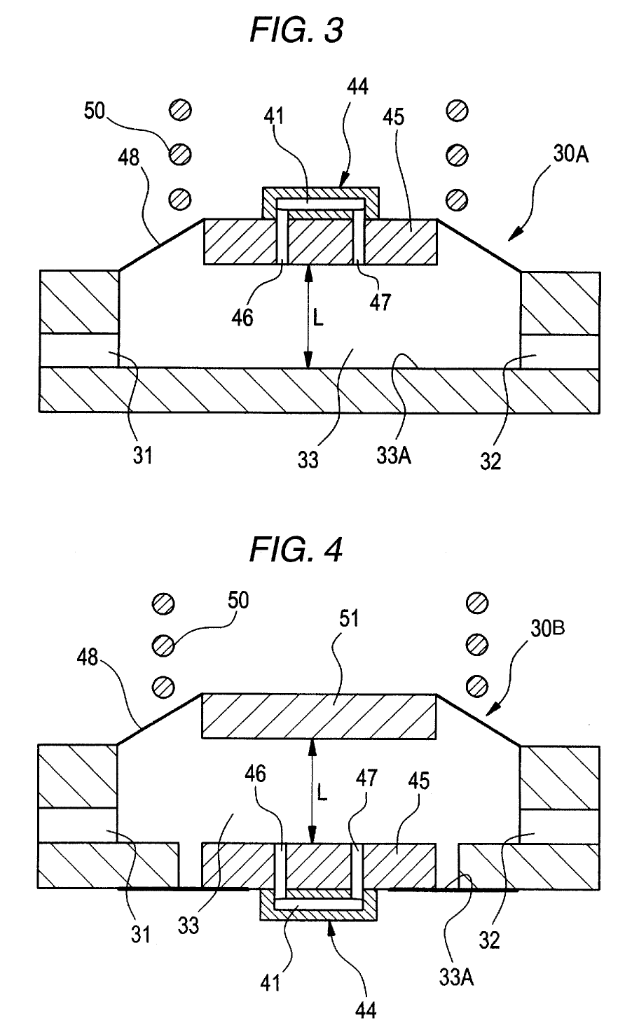

FIG. 3 is an enlarged cross-sectional view showing the structure of a liquid residual amount detection apparatus 30A according to a first embodiment of the liquid residual amount detection apparatus 30 shown in FIG. 1 or 2. The liquid residual amount detection apparatus 30 has a cylindrical liquid detection chamber (sensor chamber) 33. The liquid detection chamber 33 has openings 31 and 32 in a bottom region. In a state where the connection to the recording apparatus is made, the opening 31 is connected to the liquid inlet port 11A that is connected to the liquid containing portion 2 (2A), and the opening 32 is connected to the liquid outlet port 11B that is connected to the liquid supply port 5. An upper portion of the liquid detection chamber 33 is partitioned by a diaphragm 48.

In this embodiment, the diaphragm 48 is formed of a flexible film member, and has an opening at its center. Further, a peripheral portion of the diaphragm 48 is fixed liquid-tight to an inner peripheral wall of the sensor chamber 33 at a predetermined height from the bottom of the sensor chamber. Similarly, a peripheral portion of a support base 45 of the piezoelectric vibrating element 44 is fixed liquid-tight to the central opening of the diaphragm 48.

The piezoelectric vibrating element 44 is fixed to an upper surface of the support base 45, and a lower surface of the support base 45 is formed in parallel with the bottom inner surface 33A of the sensor chamber 33. A pair of areolar flow passages 46 and 47 are formed to pass through the support base 45 and to reach the vibrating plate of the piezoelectric vibrating element 44 from the sensor chamber 33.

The individual areolar flow passages 46 and 47 are connected to a recess portion (cavity) 41 that is formed between the vibrating plate of the piezoelectric vibrating element 44 and the support base 45. With this structure, the liquid in the sensor chamber 33 flows into the recess portion 41 through the flow passages 46 and 47, and then the vibrating plate of the piezoelectric vibrating element 44 is brought into contact with the liquid in the recess portion 41.

A pressure adjusting spring 50 (pressure adjusting member) is provided on an outer side of the sensor chamber 33 to come into contact with an upper portion of the diaphragm 48. Then, the diaphragm 48 is stably supported from the outside of the sensor chamber 33 such that the sensor chamber 33 has a predetermined space.

As an ink consuming apparatus that is connected to the liquid supply port 5 of the sensor chamber 33 is used, and the amount of the liquid in the liquid containing portion 2, particularly, the amount of the liquid in the sensor chamber 33 decreases, a liquid pressure in the sensor chamber 33 decreases, then the diaphragm 48 is gradually biased downward, and finally the lower surface of the support base 45 comes into contact with the bottom inner surface 33A of the sensor chamber 33. In this state, the areolar flow passages 46 and 47 of the support base 45 are closed by the bottom inner surface 33A of the sensor chamber 33, and thus the recess portion 41 becomes a sealed state.

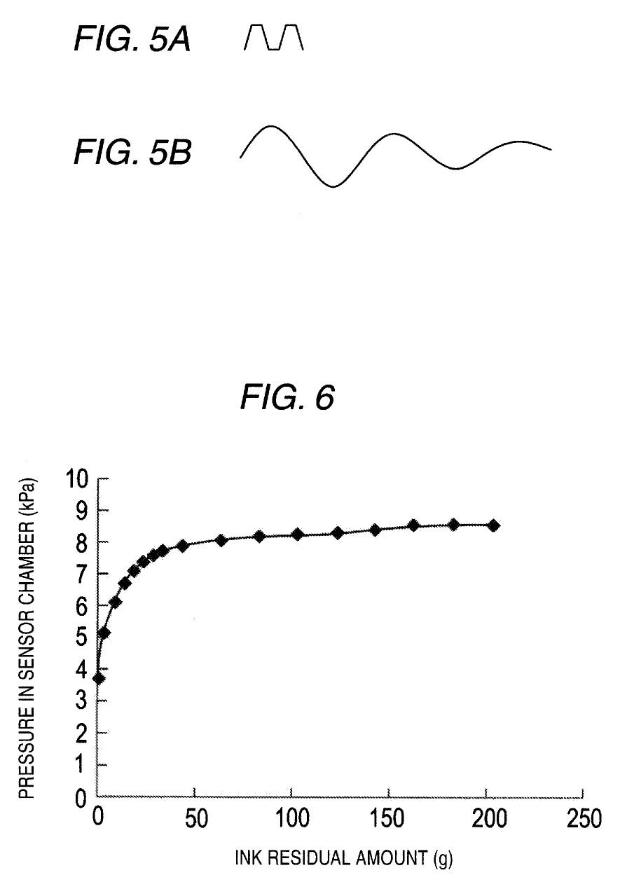

In a state where the pressure region 4 (the pressure chamber 4A) of the liquid containing portion 2 (2A) is pressurized, if a driving signal shown in FIG. 5A is supplied to the piezoelectric vibrating element 44, the piezoelectric vibrating element 44 is excited as an actuator for a predetermined time, and the vibrating plate starts free vibration. With the free vibration of the vibrating plate, a counter electromotive force is generated from the piezoelectric vibrating element 44, and the counter electromotive force is output as an output signal of an output waveform. Moreover, when the support base 45 comes into contact with the bottom inner surface 33A and the recess portion 41 is closed, the liquid in the recess portion 41 does not almost vibrate, and then the output signal from the piezoelectric vibrating element 44 becomes a substantially linear signal with no change in waveform.

FIG. 4 is an enlarged cross-sectional view showing the structure of a liquid residual amount detection apparatus 30B according to a second embodiment of the liquid residual amount detection apparatus 30 shown in FIGS. 1 or 2. In the second embodiment, the liquid residual amount detection apparatus 30B has a cylindrical liquid detection chamber (sensor chamber) 33. The liquid detection chamber 33 has openings 31 and 32 in a bottom region. In a state where the connection to the recording apparatus is made, the opening 31 is connected to the liquid inlet port 11A that is connected to the liquid containing portion 2 (2A), and the opening 32 is connected to the liquid outlet port 11B that is connected to the liquid supply port 5.

In the second embodiment, the diaphragm 48 is formed of a flexible film member, and the peripheral portion thereof is fixed liquid-tight to the inner peripheral wall of the sensor chamber 33 at a predetermined height from the bottom of the sensor chamber. A pressure receiving plate 51 is fixed to an inner central portion of the diaphragm 48.

The support base 45 of the piezoelectric vibrating element 44 is fixed liquid-tight to the bottom inner surface 33A of the sensor chamber 33, and the piezoelectric vibrating element 44 is provided at the lower surface of the support base 45. The upper surface of the support base 45 is formed in parallel with the lower surface of the pressure receiving plate 51. In addition, like the first embodiment, a pair of areolar flow passages 46 and 47 are formed to pass through the support base 45 and to reach the vibrating plate of the piezoelectric vibrating element 44 from the sensor chamber 33.

The individual areolar flow passages 46 and 47 are connected to the recess portion 41 (cavity) that is formed between the vibrating plate of the piezoelectric vibrating element 44 and the support base 45. With this structure, the liquid in the sensor chamber 33 flows into the recess portion 41 through the areolar flow passages 46 and 47, and then the vibrating plate of the piezoelectric vibrating element 44 is brought into contact with the liquid in the recess portion 41.

The pressure adjusting spring 50 (pressure adjusting member) is provided on the outer side of the sensor chamber 33 to come into contact with the upper portion of the diaphragm 48. Then, the diaphragm 48 is stably supported from the outside of the sensor chamber 33 such that the sensor chamber 33 has a predetermined space.

As an ink consuming apparatus that is connected to the liquid supply port 5 of the sensor chamber 33 operates, and the amount of the liquid in the liquid containing portion 2 (2A) decreases, a pressure in the sensor chamber 33 decreases, as shown in FIG. 6. Accordingly, the diaphragm 48 is gradually biased downward, and finally the lower surface of the pressure receiving plate 51 comes into contact with the upper surface of the support base 45 for the piezoelectric vibrating element 44 of the sensor chamber 33. In this state, the areolar flow passages 46 and 47 of the support base 45 are closed by the pressure receiving plate 51, and thus the recess portion 41 of the vibrating plate becomes a sealed state.

In a state where the pressure region 4 (the pressure chamber 4A) of the liquid containing portion 2 (2A) is pressurized, if the driving signal described in the first embodiment is supplied to the piezoelectric vibrating element, the piezoelectric vibrating element 44 is excited as an actuator for a predetermined time, and the vibrating plate starts free vibration (residual vibration). With the free vibration of the vibrating plate, a counter electromotive force is generated from the piezoelectric vibrating element 44, and the counter electromotive force is output as an output signal of an output waveform.

Here, the vibration manner by the vibrating plate will be further described. The liquid of the sensor chamber 33 exerts action on the vibrating plate through the areolar flow passages 46 and 47 of the support base 45, and then the vibrating plate of the piezoelectric vibrating element 44 freely vibrates at the comparatively large amplitude shown in FIG. 5B together with the liquid. Further, since the periphery of the pressure receiving plate 51 that faces the piezoelectric vibrating element 44 is supported to the inner peripheral wall of the sensor chamber 33 by the flexible diaphragm 48, the free vibration by the vibrating plate is amplified, and thus the counter electromotive force from the piezoelectric vibrating element 44 is amplified.

As described above, when the recording apparatus consumes ink, and ink (liquid) in the liquid containing portion 2 (2A) decreases and becomes a predetermined amount or less, the pressure receiving plate 51 that is supported on the diaphragm 48 moves downward according to the decrease of the liquid. There is a predetermined correlation between a distance L from the support base 45 of the piezoelectric vibrating element 44 to the pressure receiving plate 51 and the vibration amplitude or frequency of the vibrating plate.

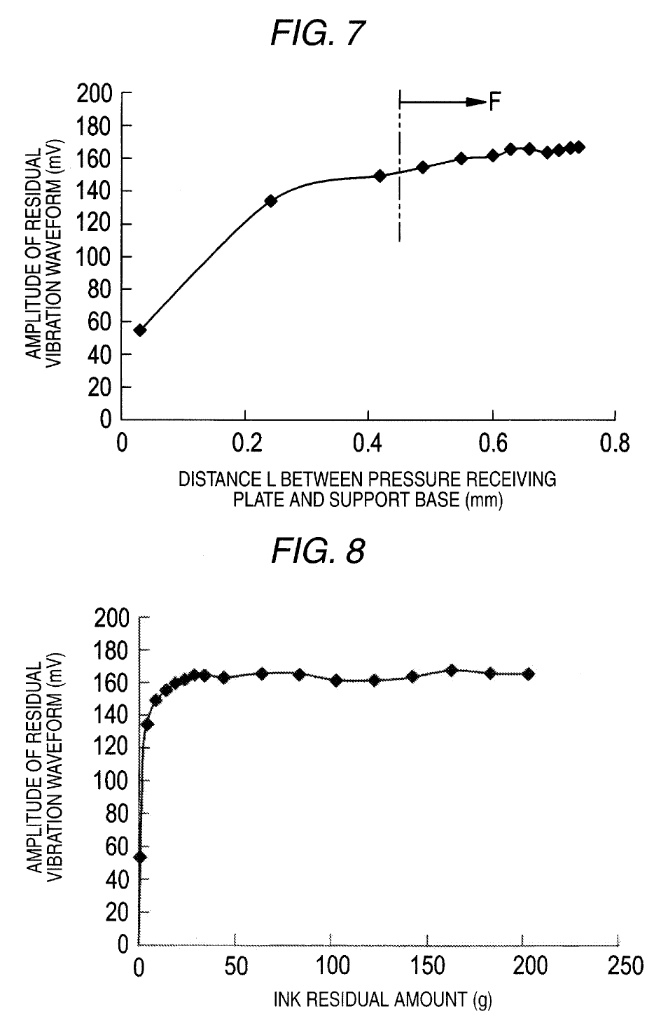

Here, the amplitude of the vibrating plate will be examined. FIG. 7 is a graph showing the relationship between the distance L from the support base 45 to the pressure receiving plate 51 in the sensor chamber 33 of the liquid residual amount detection apparatus 30B of the second embodiment and the amplitude of the residual vibration waveform. In an F region where the liquid is filled in the liquid containing portion 2 (2A) and the distance L in the sensor chamber 33 is large, the residual vibration waveform of the free vibration of the vibrating plate has a comparatively large amplitude. Further, if the height in the sensor chamber 33, that is, the value of the distance L is lowered, the amplitude of the residual vibration waveform becomes small. Moreover, in the liquid residual amount detection apparatus 30A of the first embodiment, the distance L is a distance from the support base 45 of the piezoelectric vibrating element 44 to the bottom inner surface 33A of the sensor chamber 33.

In addition, a characteristic curve of the distance L and the amplitude shown in FIG. 7 can be changed by changing an urging force of the pressure adjusting spring 50. Accordingly, a desired characteristic curve can be obtained.

In a state where the ink residual amount in the liquid containing portion 2 (2A) becomes small, there is a predetermined correlation between the height (the distance L) in the sensor chamber 33 and the volume of the liquid containing portion 2 (2A), that is, the ink residual amount in the containing portion. The amplitude of the residual vibration waveform of the counter electromotive force by the free vibration state detected by the piezoelectric element can be detected by a detection portion provided in the liquid residual amount detection apparatus 30 (30A or 30B). Further, from the amplitude of the residual vibration waveform detected by the detection portion, the ink residual amount of the liquid containing portion 2 (2A) can be calculated by a calculation portion provided in the liquid residual amount detection apparatus 30 (30A or 30B). FIG. 8 is a graph showing the relationship between the ink residual amount in the liquid containing portion 2 (2A) by the calculation portion and the amplitude of the residual vibration waveform.

Moreover, when the liquid container 1 (1A) and the recording apparatus can be electrically connected to each other, the detection portion and the calculation portion or one of them may be provided in the liquid container 1 (1A) or may be provided in the recording apparatus. When the calculation portion is provided in the recording apparatus, different calculation parameters (correlation parameters of the distance L and the ink residual amount) for liquid containers 1 (1A) having different liquid capacities may be provided in the calculation portion.

As will be apparent from the graph of FIG. 8, if the ink residual amount of the liquid containing portion 2 (2A) becomes small, the amplitude of the residual vibration waveform exponentially decreases from a certain time, and it can be judged from the amplitude value how the ink residual amount is in the liquid containing portion 2 (2A). After the pressure receiving plate 51 that is supported on the diaphragm 48 comes into contact with the upper surface of the support base 45 of the piezoelectric vibrating element 44, ink in the recess portion 41 connected to the areolar flow passages 46 and 47 of the support base 45 does not almost vibrate, and the free vibration of the vibrating plate has an extremely small amplitude. Accordingly, it is judged that ink in the liquid containing portion 2 (2A) is exhausted.

In the first and second embodiments described above, the ink residual amount in the liquid containing portion is detected from the amplitude of the residual vibration waveform by the piezoelectric vibrating element. Alternatively, through the detection of the frequency of the residual vibration other than the amplitude, similarly, the ink residual amount or ink exhaustion in the liquid containing portion can be judged.

As described above, according to the first and second embodiments of the invention, the detection portion that detects the amplitude of the residual vibration waveform by the free vibration of the vibrating plate of the piezoelectric vibrating element, and the calculation portion that calculates the liquid residual amount in the liquid containing portion on the basis of the amplitude value of the residual vibration waveform detected by the detection portion are provided. Therefore, it is possible to identify how much ink exists in the liquid containing portion, that is, how ink residual amount in the ink container of the recording apparatus is, or whether or not ink is exhausted and then lack of ink occurs.

According to the first and second embodiments, the detection of the liquid residual amount is performed by providing the piezoelectric vibrating element in the sensor chamber partitioned by the diaphragm and detecting the change in vibration waveform (amplitude or frequency) in the sensor chamber, not by attaching a piezoelectric sensor or a pressure receiving plate to an ink pack of a liquid containing portion for detection. Therefore, the displacement of the sensor chamber is accurate, and the liquid residual amount can be detected with good precision. Further, the free vibration of the vibrating plate is amplified to a higher level with the small number of parts, thereby performing the detection more accurately.

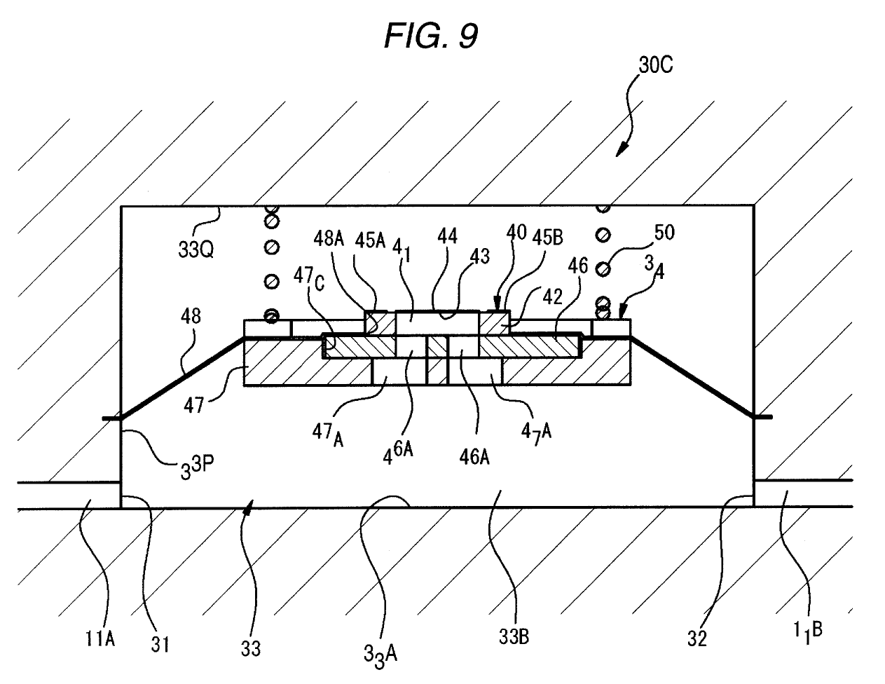

FIG. 9 is a cross-sectional view showing a structure of a liquid residual amount detection apparatus 30C according to a third embodiment of the invention of a liquid detection apparatus 30. The liquid residual amount detection apparatus 30C has a cylindrical liquid detection chamber 33. The liquid detection chamber 33 has openings 31 and 32 in a bottom region. In a state where the connection to the recording apparatus is made, the opening 31 is connected to the liquid inlet port 11A that is connected to the liquid containing portion 2, and the opening 32 is connected to the liquid outlet port 11B that is connected to the liquid supply port 5. In the liquid detection chamber 33, a piezoelectric sensor 34 is provided.

The piezoelectric sensor 34 has a sensor chip 40. The sensor chip 40 has a ceramic sensor main body 42 that has a sensor cavity 41 having a circular opening shape at its center, a vibrating plate 43 that is laminated on an upper surface of the sensor main body 42 so as to form an upper surface of the sensor cavity 41, a piezoelectric element 44 that is laminated on the vibrating plate 43, and terminals 45A and 45B that are laminated on the sensor main body 42.

The piezoelectric element 44 has upper and lower electrode layers that are respectively connected to the terminals 45A and 45B, and a piezoelectric layer that is laminated between the upper and lower electrode layers. For example, from a change in electrical characteristic of the piezoelectric element 44 by presence/absence of a liquid in the sensor cavity 41, it is judged whether or not the liquid is confined in the sensor cavity 41.

In the sensor chip 40, a lower surface of the sensor main body 42 is integrally fixed to a central portion of an upper surface of a metal sensor base 46 by an adhesive layer. The sensor base 46 and the sensor chip 40 are sealed by the adhesive layer.

The sensor base 46, on which the sensor chip 40 is mounted, is accommodated in a recess portion 47C formed in a unit base 47. The sensor base 46 and the unit base 47 are covered by a resin diaphragm 48 from the above and are integrally fixed.

In the diaphragm 48, an opening 48A is formed at its center. In a state where the sensor base 46 is accommodated in the recess portion 47C of the upper surface of the unit base 47, the diaphragm 48 is covered from the above and then adhered. At this time, the sensor chip 40 is exposed from the opening 48A at the center.

That is, the inner periphery of the diaphragm 48 is covered on the upper surfaces of the sensor base 46 and the unit base 47, and then the sensor base 46 and the unit base 47 are fixed to each other and sealed.

The diaphragm 48 is formed of a resin film on which aluminum is laminated. Accordingly, the periphery of the diaphragm is fixed liquid-tight at a predetermined height at an inner peripheral wall 33P forming the liquid detection chamber 33.

Then, the piezoelectric sensor 34 is supported by the diaphragm 48 to be displaced up and down in the liquid detection chamber 33.

The liquid detection chamber 33 is vertically divided by the piezoelectric sensor 34 supported on the diaphragm 48, and a space connected to the liquid inlet port 11A and the liquid outlet port 11B becomes a pressure sensor chamber 33B. Ink is delivered from the liquid containing portion 2 into the pressure sensor chamber 33B through the liquid inlet port 11A.

In the sensor base 46 and the unit base 47, flow passages 46A and 47A that are connected to each other are formed. The flow passages 46A and 47A are connected to the sensor cavity 41 of the sensor chip 40. When the piezoelectric sensor 34 is displaced downward, the lower surface of the unit base 47 can come into contact with a bottom surface 33A forming the liquid detection chamber 33. At this time, the flow passages 46A and 47A can be disconnected from the pressure sensor chamber 33B.

In the piezoelectric sensor 34, a compression spring (urging member) 50 is provided in a space with the upper surface 33Q of the liquid detection chamber 33. With the compression spring 50, the piezoelectric sensor 34 is urged toward the bottom surface 33A of the liquid detection chamber 33.

With this structure, in a state where air serving as a pressurized fluid is not supplied to the pressure region 4, since an urging force of the compression spring 50 exerts action on the piezoelectric sensor 34, the liquid detection apparatus 30C having the piezoelectric sensor 34 is located at the bottom surface.

Here, the urging force of the compression spring 50 is set to be weaker than the liquid pressure of ink that delivered to the pressure sensor chamber 33B when air as a pressurized fluid is supplied to the pressure region 4. Accordingly, the piezoelectric sensor 34 is displaced upward against the urging force of the compression spring 50 by the liquid pressure of ink delivered to the pressure sensor chamber 33B.

In this state, ink in the pressure sensor chamber 33B enters the sensor cavity 41 through the flow passages 46A and 47A of the sensor base 46 and the unit base 47.

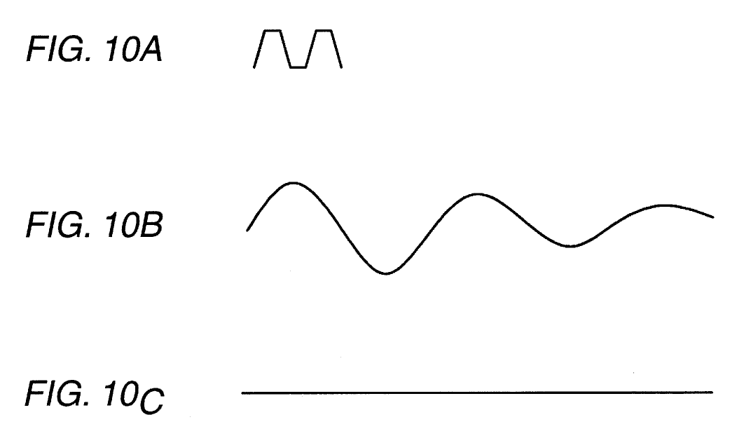

If a charging/discharging waveform shown in FIG. 10A is applied to the piezoelectric element 44 of the piezoelectric sensor 34 having the above configuration, a vibration system having the vibrating plate 43, the piezoelectric element 44, and the liquid or air freely vibrates. The free vibration (residual vibration) causes the piezoelectric element 44 to generate a counter electromotive force by a piezoelectric effect. Therefore, a vibration cycle can be measured by measuring a cycle of the counter electromotive force.

Next, a case where the ink cartridge 1 having the liquid detection apparatus 30C having the above configuration is mounted on the recording apparatus and used will be described.

If the ink cartridge 1 is mounted on a mounting portion of the recording apparatus, the liquid introduction needle 6 of the mounting portion is engaged with the liquid supply port 5, and the valve 8 is retracted. Further, a pressurized fluid supply source (not shown) is connected to the pressure region 4. Moreover, preferably, the pressure region 4 is guided to a surface, at which the liquid supply port 5 is formed, by a flow passage so as to be connected to the pressurized fluid supply source when the ink cartridge 1 is mounted on the recording apparatus.

As described above, in a state where the ink cartridge 1 is mounted on the mounting portion of the recording apparatus, if air is supplied from the pressurized fluid supply source to the pressure region 4, the liquid containing portion 2 is pressurized through the flexible film body 3 by air flowing into the pressure region 4.

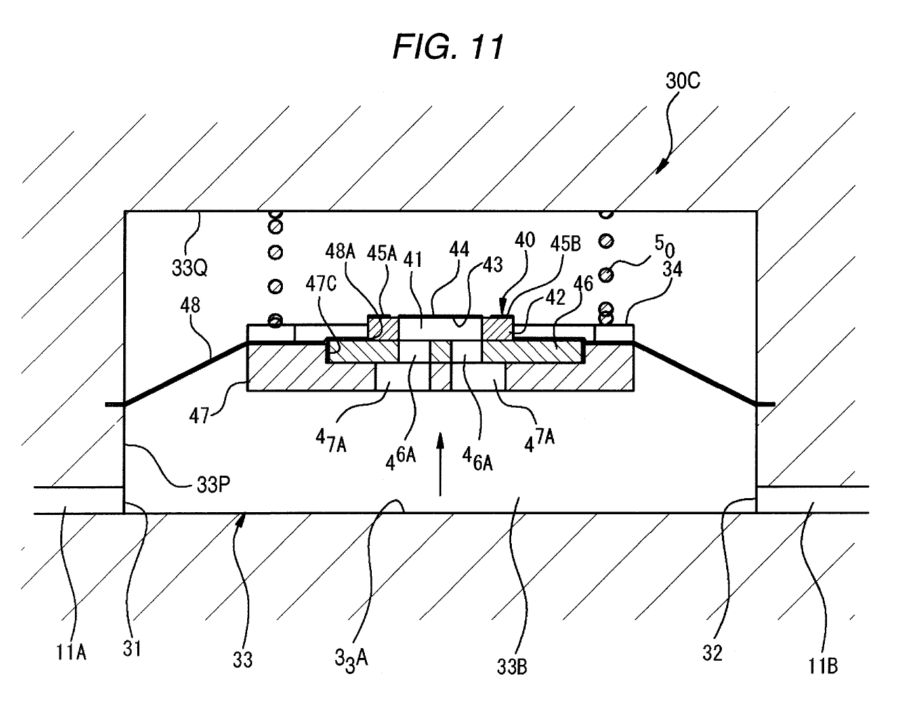

Accordingly, ink in the liquid containing portion 2 flows into the pressure sensor chamber 33B of the liquid detection chamber 33 through the liquid inlet port 11A, and then the piezoelectric sensor 34 of the liquid detection chamber 33 rises against the urging force of the compression spring 50 by the liquid pressure of ink flowing into the pressure sensor chamber 33B, as shown in FIG. 11.

Accordingly, ink in the pressure sensor chamber 33B enters the sensor cavity 41 through the flow passages 46A and 47A of the sensor base 46 and the unit base 47 of the piezoelectric sensor 34.

Then, ink flowing into the pressure sensor chamber 33B is delivered from the liquid introduction needle 6 to the flow passage in the recording apparatus through the liquid outlet port 11B and is used for printing in the recording head.

As described above, in a state where ink is filled in the pressure sensor chamber 33B, if the driving signal shown in FIG. 10A is applied to the piezoelectric element 44, the piezoelectric element 44 is excited as an actuator for a predetermined time, and the vibrating plate 43 starts the free vibration. Accordingly, a counter electromotive force is generated from the piezoelectric element 44 by the free vibration of the vibrating plate 43, and the counter electromotive force is output as an output signal of an output waveform.

Here, the vibrating plate 43 of the piezoelectric sensor 34 freely vibrates at a comparatively large amplitude shown in FIG. 10B at which ink filled in the sensor cavity 41, the flow passages 46A and 47A, and the pressure sensor chamber 33B vibrates. Further, the periphery of the piezoelectric sensor 34 is supported at the inner peripheral wall 33P of the liquid detection chamber 33 by the flexible diaphragm 48. Accordingly, the free vibration of the vibrating plate 43 is amplitude, and then the counter electromotive force from the piezoelectric element 44 is amplified.

When the recording apparatus consumes ink, and ink in the liquid containing portion 2 decreases, even though pressurized air is supplied from the pressurized fluid supply source, ink does not flow into the pressure sensor chamber 33B of the liquid detection chamber 33. For this reason, ink in the pressure sensor chamber 33B decreases only when the recording apparatus consumes ink.

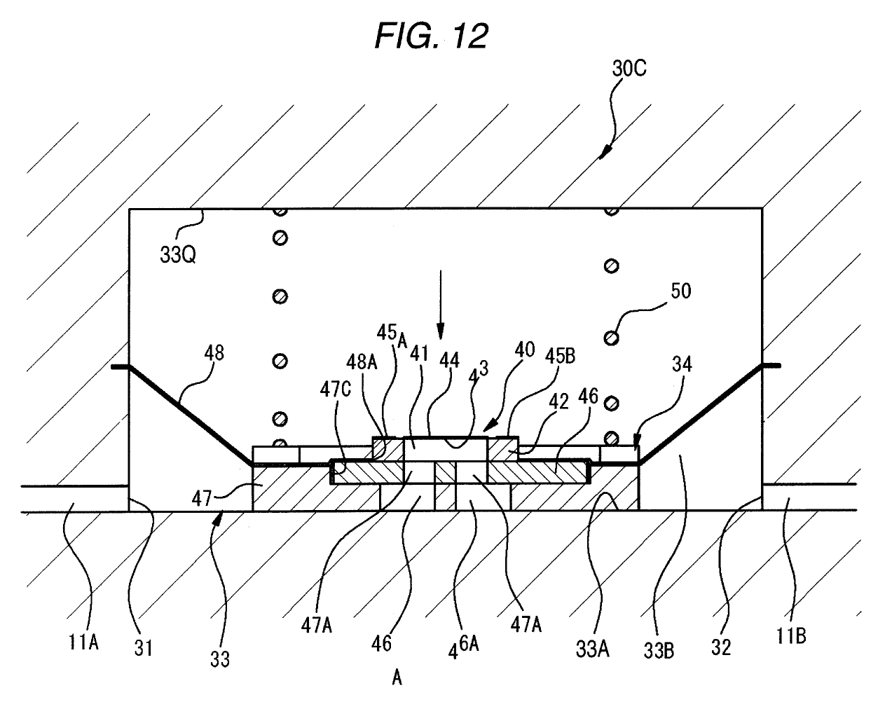

If ink in the pressure sensor chamber 33B decreases to a predetermined amount or less, the piezoelectric sensor 34 supported on the diaphragm 48 moves downward by the urging force of the compression spring 50 according to the decrease of ink. Then, if the piezoelectric sensor 34 reaches the bottom surface 33A of the liquid detection chamber 33, as shown in FIG. 12, the unit base 47 is pressed against the bottom surface 33A of the liquid detection chamber 33, and then the sensor cavity 41 and the flow passages 46A and 47A are disconnected from the pressure sensor chamber 33B.

In this state, if the driving signal shown in FIG. 11A is supplied to the piezoelectric element 44, the piezoelectric element 44 is excited as an actuator for a predetermined time, and the vibrating plate 43 starts the free vibration. Accordingly, the counter electromotive force is generated from the piezoelectric element 44 by the free vibration of the vibrating plate 43, and the counter electromotive force is output as an output signal of an output waveform.

Here, since ink in the sensor cavity 41 and the flow passages 46A and 47A disconnected from the pressure sensor chamber 33B does not almost vibrate, the vibrating plate 43 of the piezoelectric sensor 34 does not almost set up the free vibration, and thus the output signal from the piezoelectric element 44 becomes a signal with no change in waveform, as shown in FIG. 10C.

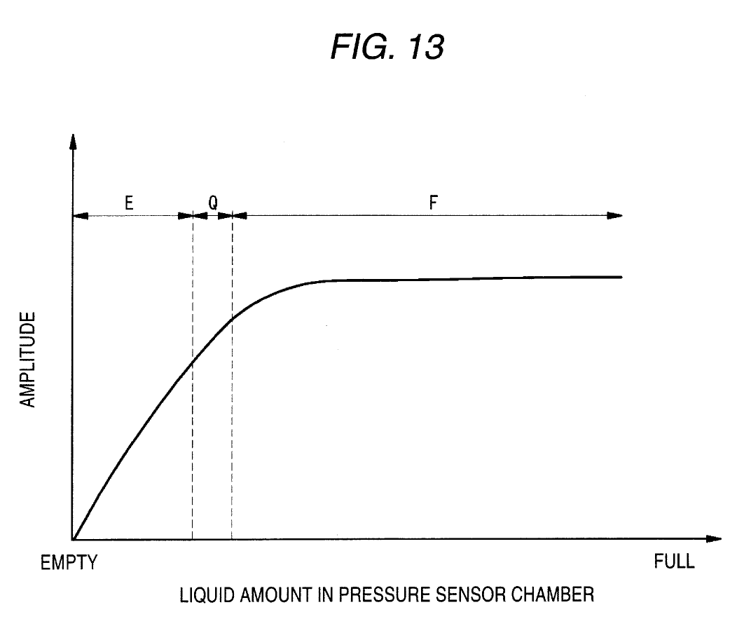

FIG. 13 is a graph showing the relationship between the amount of ink in the pressure sensor chamber 33B and the amplitude of the vibrating plate 43 of the piezoelectric sensor 34.

As described above, in the above liquid detection apparatus 30C, in an F region of FIG. 13 where ink is filled in the pressure sensor chamber 33B, the free vibration of the vibrating plate 43 has a comparatively large amplitude at which ink filled in the sensor cavity 41, the flow passages 46A and 47A, and the pressure sensor chamber 33B vibrates.

Further, in a Q region of FIG. 13 where ink in the pressure sensor chamber 33B decreases and the piezoelectric sensor 34 moves downward according to the decrease of ink in the pressure sensor chamber 33B, the amplitude of the free vibration of the vibrating plate 43 is made excessively small according to the decrease of the ink amount in the pressure sensor chamber 33B.

Then, in an E region of FIG. 13 after the piezoelectric sensor 34 reaches the bottom surface 33A of the liquid detection chamber 33, the free vibration of the vibrating plate 43 has an extremely small amplitude at which ink in the sensor cavity 41 and the flow passages 46A and 47A does not almost vibrate.

Therefore, according to the above liquid detection apparatus 30C, by monitoring the change in amplitude of the free vibration of the vibrating plate 43 (presence/absence of the amplitude) on the basis of the output signal from the piezoelectric element 44, it is possible to easily detect that ink of the liquid containing portion 2 consumes and is exhausted or that the supply of pressurized air from the pressurized fluid supply source stops.

As described above, according to the liquid detection apparatus 30C of the above-described embodiment and the ink cartridge 1 having the same, by causing the piezoelectric element 44 to apply the vibration to ink and monitoring the change in amplitude of the free vibration of the vibrating plate 43, it is possible to reliably detect the state (presence/absence) of ink in the pressure sensor chamber 33B. Moreover, by monitoring a change in frequency of the free vibration of the vibrating plate 43, instead of monitoring the change in amplitude of the free vibration of the vibrating plate 43, the state (presence/absence) of ink can be detected.

In particular, since the piezoelectric sensor 34 having the vibrating plate 43 is supported on the flexible diaphragm 48, the free vibration of the vibrating plate 43 can be amplified to a higher level with the small number of parts, and the state of ink in the pressure sensor chamber 33B can be reliably detected.

Therefore, so-called idle printing, that is, a phenomenon that, when the recording apparatus operates in a state where the ink cartridge 1 is empty and ink is not supplied, can be eliminated, and thus the recording head of the recording apparatus can be prevented from being damaged due to idle printing.

Further, since the compression spring 50 that urges the piezoelectric sensor 34 toward the bottom surface 33A of the liquid detection chamber 33 forming the pressure sensor chamber 33B is provided, when the liquid amount in the pressure sensor chamber 33B decreases, the piezoelectric sensor 34 can be reliably brought into contact with the bottom surface 33A of the pressure sensor chamber 33B by the compression spring 50, thereby closing the cavity.

That is, when ink in the pressure sensor chamber 33B decreases, a vibration reaction region by the piezoelectric element 44 can be reliably changed, thereby smoothly detecting presence/absence of the liquid in the pressure sensor chamber 33B.

In addition, since the compression spring 50 has an urging force weaker than the pressure of ink flowing into the pressure sensor chamber 33B, the piezoelectric sensor 34 can be reliably displaced according to the decrease in liquid pressure in the pressure sensor chamber 33B. Further, an erroneous operation, for example, the displacement of the piezoelectric sensor 34 regardless of the presence of ink in the pressure sensor chamber 33B can be eliminated. As a result, the liquid can be detected with high precision.

Furthermore, since the diaphragm 48 is formed of an aluminum-laminated film on which aluminum is laminated, airtightness in the diaphragm can be increased, gas can be prevented from entering ink in the pressure sensor chamber 33B, and a high degree of deaeration can be maintained.

Moreover, in the above-described embodiment, a case where the liquid detection apparatus 30C is applied to the ink cartridge 1 of the recording apparatus will be described. However, the invention is not limited to the ink cartridge 1 of the recording apparatus. For example, the liquid detection apparatus 30C can be applied to a printing apparatus or a microdispenser, in addition to the recording apparatus. Further, the liquid detection apparatus 30C may be directly provided in the flow passage of the liquid or the like of the above apparatuses.

Furthermore, in the liquid detection apparatus 30C, the piezoelectric sensor 34 is urged toward the bottom surface 33A of the pressure sensor chamber 33B by the urging member having the compression spring 50. However, the urging member is not limited to the compression spring 50. For example, a tension spring that pulls the piezoelectric sensor 34 toward the bottom surface 33A of the pressure sensor chamber 33B may be used.

Hereinafter, a fourth embodiment of a liquid detection apparatus according to the invention and a liquid container having the same will be described with reference to the drawings. Moreover, in this embodiment, the description will be given by way of a closed ink cartridge that is mounted on a recording apparatus, as a liquid container.

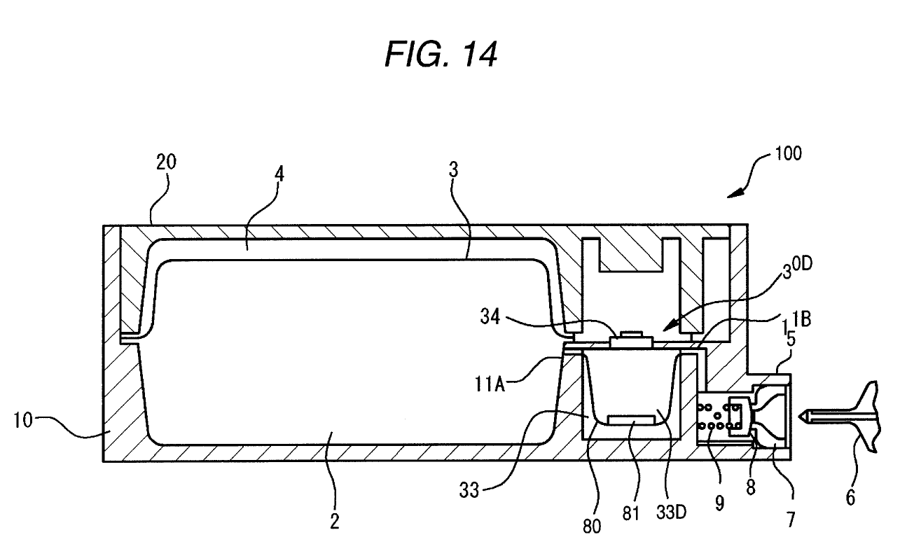

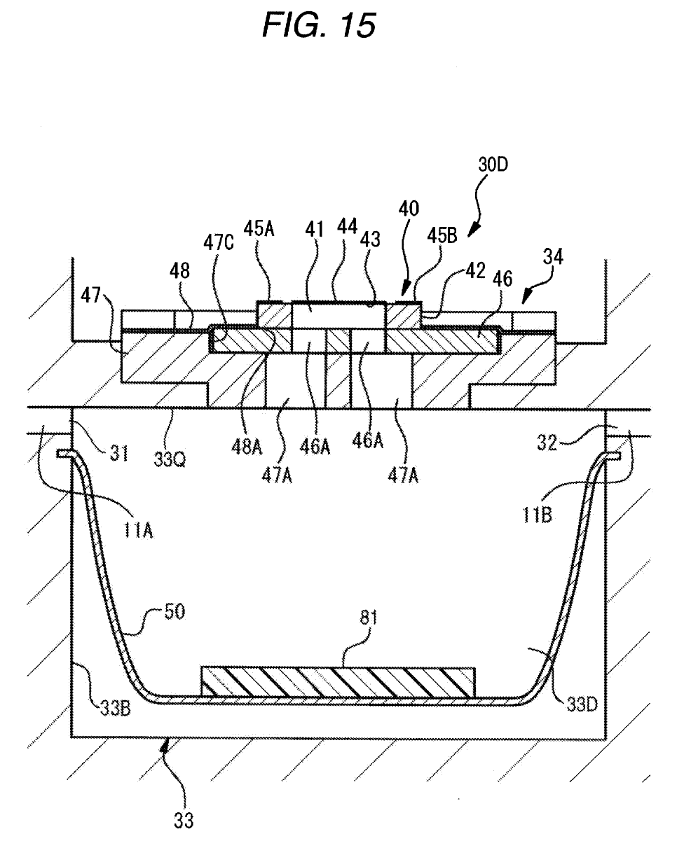

FIG. 14 is a cross-sectional view showing an embodiment of a liquid container having a liquid detection apparatus according to the invention. FIG. 15 is a cross-sectional view showing the structure of the liquid detection apparatus.

As shown in FIG. 14, an ink cartridge (liquid container) 100 is mounted on the recording apparatus, and includes a case having a first case 10 and a second case 20. The first case 10 and the second case 20 have a box shape with a bottom and are united so as to form a half shell. In the first case 10, an opening is formed so as to form a liquid containing portion 2 that contains a liquid, such as ink or the like. The opening is covered with a flexible film body 3 formed of a resin film or the like. The flexible film body 3 is bonded to the periphery of the first case 10 through thermal welding. Meanwhile, on the other side of the flexible film body 3, the periphery of the second case 20 is pressed into contact with a thermally welded portion of the flexible film body 3, such that an airtight space is formed between the second case 20 and the flexible film body 3. The airtight space becomes a pressure region 4 into which a pressurized fluid (pressurized air) is introduced by a pressurized fluid introduction port (not shown) from the outside. If the pressurized fluid is introduced into the pressure region 4, the flexible film body 3 is pressurized, and the liquid in the first case 10 is pressurized in a direction in which the liquid is discharged to the outside.

Moreover, the liquid containing portion 2 may have the cases and the flexible film body shown in FIG. 14 or may have an ink pack that is formed by adhering flexible resin films, such as aluminum-laminated films or the like, and then is accommodated in an ink cartridge.

On an outer surface of the first case 10, a liquid supply port 5 is formed so as to be connected to a liquid supply path of the recording apparatus. In the liquid supply port 5, a packing 7 that has an opening to be brought into elastic contact with a periphery of a liquid introduction needle 6 connected to a recording head of the recording apparatus, a valve body 8 that comes into contact with an end surface of the packing 7 so as to seal the opening of the packing 7, and a spring 9, such as a coil spring or the like, that urges the valve body 8 toward the packing 7 are provided.

In the liquid supply port 5, a valve constantly keeps a closed state by the spring 9 in a state where the connection to the recording apparatus is not made. Further, when the connection to the recording apparatus is made, the valve body 8 is pressed by the liquid introduction needle 6 in a direction in which the valve is opened, such that the valve is opened.

The liquid supply port 5 and the liquid containing portion 2 are connected to each other through a liquid inlet port 11A and a liquid outlet port 11B. A liquid detection apparatus 30D is provided between the liquid inlet port 11A and the liquid outlet port 11B.

FIG. 15 is a cross-sectional view showing the liquid detection apparatus 30D. The liquid detection apparatus 30D has a cylindrical liquid detection chamber 33. The liquid detection chamber 33 has openings 31 and 32 in a bottom region. In a state where the connection to the recording apparatus is made, the opening 31 is connected to the liquid inlet port 11A that is connected to the liquid containing portion 2, and the opening 32 is connected to the liquid outlet port 11B that is connected to the liquid supply port 5. A piezoelectric sensor 34 is provided at an upper surface 33Q of the liquid detection chamber 33.

The piezoelectric sensor 34 has a sensor chip 40. The sensor chip 40 a ceramic sensor main body 42 that has a sensor cavity 41 having a circular opening shape at its center, a vibrating plate 43 that is laminated on an upper surface of the sensor main body 42 so as to form an upper surface of the sensor cavity 41, a piezoelectric element 44 that is laminated on the vibrating plate 43, and terminals 45A and 45B that are laminated on the sensor main body 42.

The piezoelectric element 44 has upper and lower electrode layers that are respectively connected to the terminals 45A and 45B, and a piezoelectric layer that is laminated between the upper and lower electrode layers. For example, from a change in electrical characteristic of the piezoelectric element 44 by presence/absence of a liquid in the sensor cavity 41, it is judged whether or not the liquid is confined in the sensor cavity 41.

In the sensor chip 40, a lower surface of the sensor main body 42 is integrally fixed to a central portion of an upper surface of a metal sensor base 46 by an adhesive layer. The sensor base 46 and the sensor chip 40 are sealed by the adhesive layer.

The sensor base 46, on which the sensor chip 40 is mounted, is accommodated in a recess portion 47C formed in a unit base 47. The sensor base 46 and the unit base 47 are covered by a resin adhesive film 48 from the above and are integrally fixed.

In the adhesive film 48, an opening 48A is formed at its center. In a state where the sensor base 46 is accommodated in the recess portion 47C of the upper surface of the unit base 47, the adhesive film 48 is covered from the above and then adhered. At this time, the sensor chip 40 is exposed from the opening 48A at the center.

That is, the inner periphery of the adhesive film 48 is adhered to the upper surfaces of the sensor base 46 and the unit base 47, and then the sensor base 46 and the unit base 47 are fixed to each other and sealed.

In the sensor base 46 and the unit base 47, flow passages 46A and 47A that are connected to each other are formed. The flow passages 46A and 47A are connected to the sensor cavity 41 of the sensor chip 40.

In the liquid detection chamber 33, a support film (film) 80 formed of a resin film having liquid-tightness and flexibility is provided. The support film 80 is formed in a recess shape, and the periphery of the support film 80 is fixed liquid-tight at a position lower than the openings 31 and 32 in an inner peripheral wall 33B forming the liquid detection chamber 33.

With the support film 80, a pressure sensor chamber 33D that is surrounded by the upper surface 33Q of the liquid detection chamber 33 having provided therein the piezoelectric sensor 34, a portion of an upper end of the inner peripheral wall 33B of the liquid detection chamber 33, and the support film 80 is formed.

Ink is delivered from the liquid containing portion 2 into the pressure sensor chamber 33D through the liquid inlet port 11A, and ink flowing into the pressure sensor chamber 33D enters the sensor cavity 41 through the flow passages 46A and 47A of the sensor base 46 and the unit base 47.

A plate-shaped vibration absorption member 81 is provided at a bottom of the support film 80. Accordingly, the vibration absorption member 81 can be displaced in a direction close to or distant from the piezoelectric sensor 34 when the support film 80 is deformed. The vibration absorption member 81 is formed of an elastic material having excellent vibration absorbability. For example, rubber, sponge, or MNCS (Micro Network Controlled Structure) may be used. The MNCS has liquid resistance, and thus is preferably used as the vibration absorption member 81. An upper surface of the vibration absorption member 81 has a size enough to cover the flow passage 47A formed in the unit base 47 of the piezoelectric sensor 34.

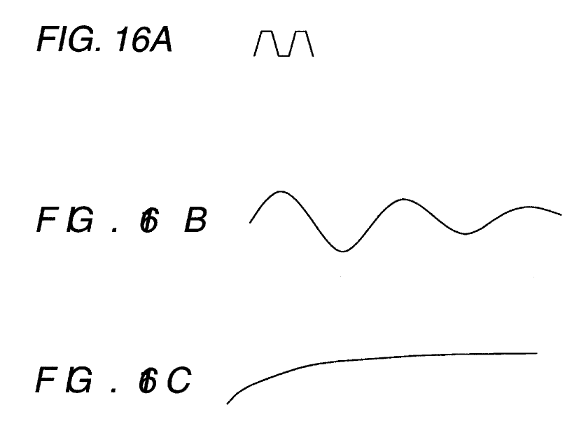

If a charging/discharging waveform shown in FIG. 16A is applied to the piezoelectric element 44 of the piezoelectric sensor 34 having the above configuration, a vibration system having the vibrating plate 43, the piezoelectric element 44, and the liquid or air freely vibrates. The free vibration (residual vibration) causes the piezoelectric element 44 to generate a counter electromotive force by a piezoelectric effect. Therefore, a vibration cycle can be measured by measuring a cycle of the counter electromotive force.

Next, a case where the ink cartridge 10 having the liquid detection apparatus 30D having the above configuration is mounted on the recording apparatus and used will be described.

If the ink cartridge 100 is mounted on a mounting portion of the recording apparatus, the liquid introduction needle 6 of the mounting portion is engaged with the liquid supply port 5, and the valve B is retracted. Further, a pressurized fluid supply source (not shown) is connected to the pressure region 4. Moreover, preferably, the pressure region 4 is guided to a surface, at which the liquid supply port 5 is formed, by a flow passage so as to be connected to the pressurized fluid supply source when the ink cartridge 100 is mounted on the recording apparatus.

As described above, in a state where the ink cartridge 100 is mounted on the mounting portion of the recording apparatus, if air is supplied from the pressurized fluid supply source to the pressure region 4, the liquid containing portion 2 is pressurized through the flexible film body 3 by air flowing into the pressure region 4.

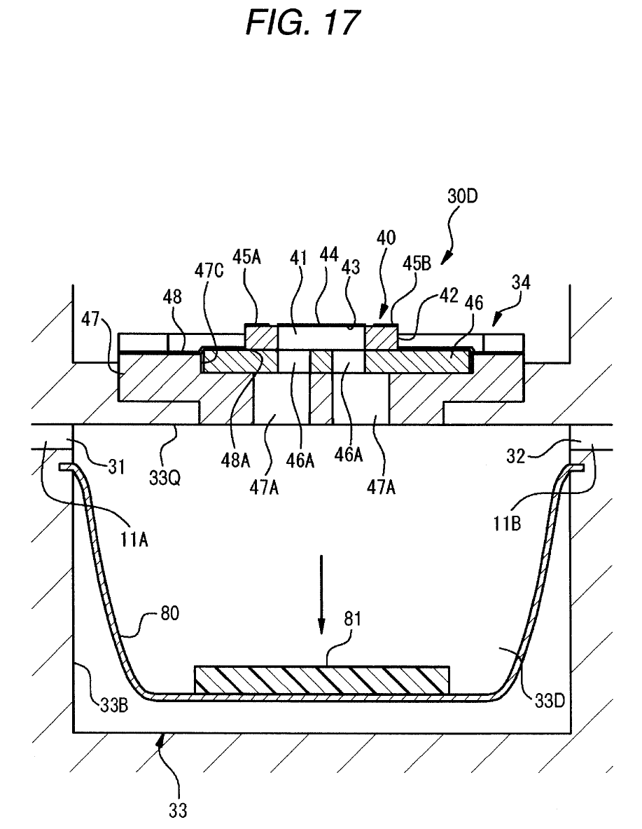

Accordingly, as shown in FIG. 17, ink in the liquid containing portion 2 flows into the pressure sensor chamber 33D of the liquid detection chamber 33 through the liquid inlet port 11A, and then ink in the pressure sensor chamber 33D enters the sensor cavity 41 through the flow passages 46A and 47A of the sensor base 46 and the unit base 47 of the piezoelectric sensor 34.

Then, ink flowing into the pressure sensor chamber 33D is delivered from the liquid introduction needle 6 to the flow passage in the recording apparatus through the liquid outlet port 11B and is used for printing in the recording head.

As described above, in a state where ink is filled in the pressure sensor chamber 33D, if the driving signal shown in FIG. 16A is applied to the piezoelectric element 44, the piezoelectric element 44 is excited as an actuator for a predetermined time, and the vibrating plate 43 starts the free vibration. Accordingly, a counter electromotive force is generated from the piezoelectric element 44 by the free vibration of the vibrating plate 43, and the counter electromotive force is output as an output signal of an output waveform.

Here, the vibrating plate 43 of the piezoelectric sensor 34 freely vibrates at a comparatively low frequency shown in FIG. 16B that id determined by ink filled in the sensor cavity 41, the flow passages 46A and 47A, and the pressure sensor chamber 33D.

When the recording apparatus consumes ink, and ink in the liquid containing portion 2 decreases, even though pressurized air is supplied from the pressurized fluid supply source, ink does not flow into the pressure sensor chamber 33D of the liquid detection chamber 33. For this reason, ink in the pressure sensor chamber 33D decreases only when the recording apparatus consumes ink.

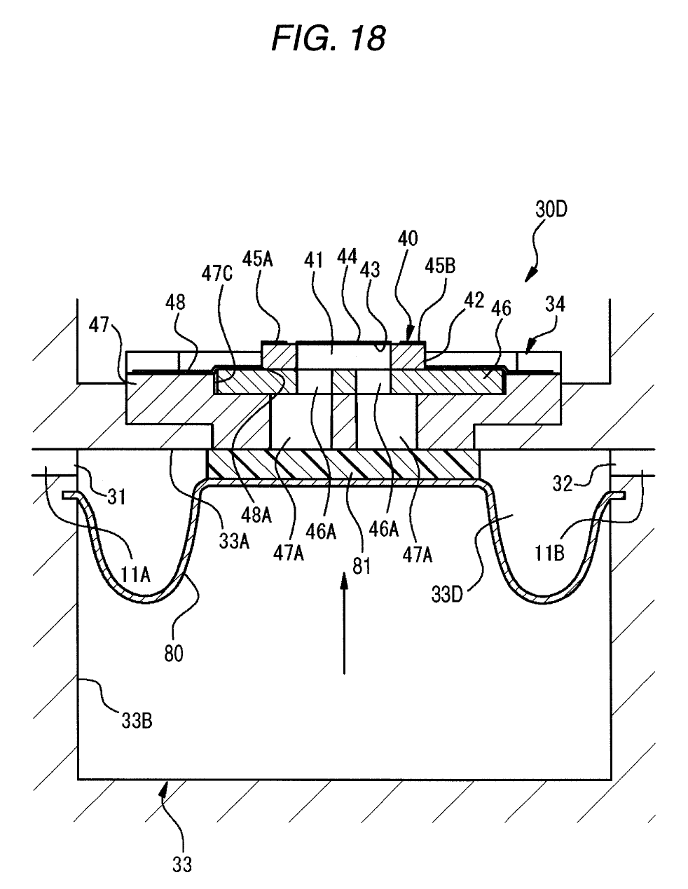

If ink in the pressure sensor chamber 33D decreases to a predetermined amount or less and a negative pressure is generated, the support film 80 gradually does down according to the decrease in volume in the pressure sensor chamber 33D. Accordingly, the vibration absorption member 81 disposed at the bottom of the support film 80 is lifted according to the decrease of ink in the pressure sensor chamber 33D and is pushed toward the piezoelectric sensor 34. Then, if the vibration absorption member 81 reaches the piezoelectric sensor 34, as shown in FIG. 18, the vibration absorption member 81 is pressed against the bottom of the piezoelectric sensor 34, and then the sensor cavity 41 and the flow passages 46A and 47A are disconnected from the pressure sensor chamber 33D.

In this state, if the driving signal shown in FIG. 16A is supplied to the piezoelectric element 44, the piezoelectric element 44 is excited as an actuator for a predetermined time, and the vibrating plate 43 starts the free vibration. Accordingly, the counter electromotive force is generated from the piezoelectric element 44 by the free vibration of the vibrating plate 43, and the counter electromotive force is output as an output signal of an output waveform.

The vibrating plate 43 of the piezoelectric sensor 34 is determined by ink in the sensor cavity 41 and the flow passages 46A and 47A disconnected from the pressure sensor chamber 33D. However, since the vibration absorption member 81 that is formed of an elastic material having excellent vibration absorbability comes into contact with the bottom of the piezoelectric sensor 34, the vibration transferred to ink is absorbed by a vibration absorption effect of the vibration absorption member 81. Accordingly, the free vibration does not almost occur, and the output signal from the piezoelectric element 44 becomes a signal with no change in waveform, as shown in FIG. 16C.

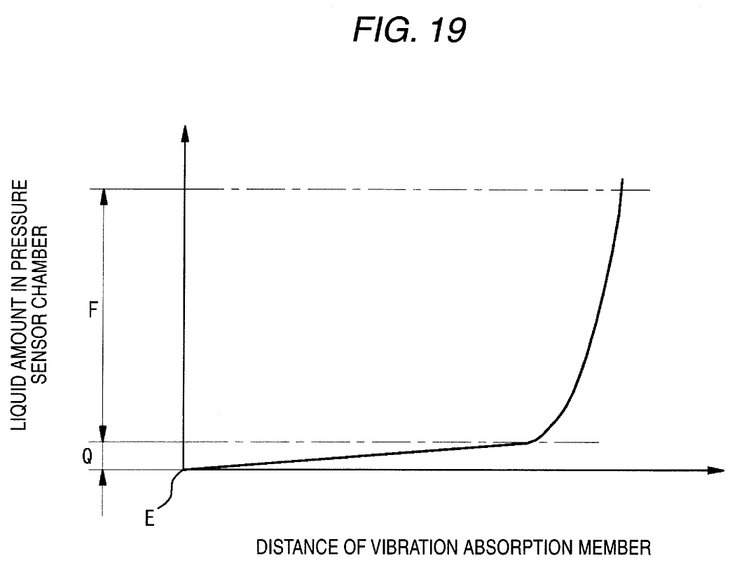

FIG. 19 is a graph showing the relationship between the amount of ink in the pressure sensor chamber 33D and the distance from the vibration absorption member 81 to the piezoelectric sensor 34.

As shown in FIG. 19, until the amount of ink in the pressure sensor chamber 33D significantly decreases, a change in distance of the vibration absorption member 81 to the piezoelectric sensor 34 is small, as indicated by an F region in FIG. 19. In the region F, the output signal from the piezoelectric element 44 has a comparatively large waveform.

If ink in the pressure sensor chamber 33D further decreases and a negative pressure is generated, the vibration absorption member 81 moves toward the piezoelectric sensor 34 so much according to the decrease of ink thereafter, as indicated by a Q region in FIG. 19. Then, the waveform of the output signal from the piezoelectric element 44 is rapidly removed by the vibration absorption effect of the vibration absorption member 81.

Then, as indicated by an E region in FIG. 19, if ink in pressure sensor chamber 33D is almost eliminated, the vibration absorption member 81 is closely adhered to the bottom of the piezoelectric sensor 34, and the sensor cavity 41 and the flow passages 46A and 47A are closed by the vibration absorption member 81. Then, the vibration in the closed space is almost absorbed by the vibration absorption member 81, and the waveform of the output signal from the piezoelectric element 44 is almost removed.

Therefore, according to the above-described liquid detection apparatus 30D, by monitoring a change in frequency of the free vibration of the vibrating plate 43 on the basis of the output signal from the piezoelectric element 44, it is possible to easily detect that ink of the liquid containing portion 2 consumes and is exhausted or that the supply of pressurized air from the pressurized fluid supply source stops.

As described above, according to the liquid detection apparatus 30D according to the above embodiment and the ink cartridge 100 having the same, by causing the piezoelectric element 44 to apply the vibration to ink and monitoring the change in amplitude (presence/absence of the amplitude or the like) of free vibration of the vibrating plate 43 or the change in frequency of the free vibration, the state of ink in the pressure sensor chamber 33D can be reliably detected.

In particular, since the piezoelectric sensor 34 and the vibration absorption member 81 can be relatively displaced close to or distant from each other according to the ink amount in the pressure sensor chamber 33D, the output waveform of the piezoelectric element 44 can be changed so much by the vibration absorption effect of the vibration absorption member according to the change in ink amount of the pressure sensor chamber 33D, and thus the state of the liquid in the pressure sensor chamber 33D can be reliably detected.

Accordingly, so-called idle printing, that is, a phenomenon that, when the recording apparatus operates in a state where the ink cartridge 100 is empty and ink is not supplied, can be eliminated, and thus the recording head of the recording apparatus can be prevented from being damaged due to idle printing.

Besides, as the ink amount in the pressure sensor chamber 33D decreases, the detection of the decrease in ink amount in the pressure sensor chamber 33D is performed on the basis of the output signal from the piezoelectric element 44 when the vibration absorption member 81 comes into contact with the piezoelectric sensor 34. Therefore, the vibration of the liquid can be reliably absorbed by the vibration absorption member 81, and thus the detection of the decrease in ink of the pressure sensor chamber 33D can be reliably performed.

In addition, the vibration absorption member 81 is supported on the flexible support film 80 forming a portion of the pressure sensor chamber 33D, and, when the support film 80 is deformed by the ink amount in the pressure sensor chamber 33D, the vibration absorption member 81 is displaced in a direction close to or distant from the piezoelectric sensor 34. Therefore, with the support film 80 that is deformed according to the change in ink amount of the pressure sensor chamber 33D, the vibration absorption member 81 can be favorably displaced in the direction close to or distant from the piezoelectric sensor 34. As a result, the state of the liquid in the pressure sensor chamber 33D can be reliably detected.

Moreover, in the liquid detection apparatus 30D, the detection of the decrease in ink amount of the pressure sensor chamber 33D is performed on the basis of the output signal from the piezoelectric element 44 when the vibration absorption member 81 comes into contact with the piezoelectric sensor 34. Alternatively, as the ink amount in the pressure sensor chamber 33D decreases, the detection of the decrease in ink amount of the pressure sensor chamber 33D may be performed on the basis of an output signal from the piezoelectric element 44 when the vibration absorption member 81 is close to the piezoelectric sensor 34.

With this configuration, when the vibration absorption member 81 is close to the piezoelectric sensor 34, the vibration of the liquid can be reliably absorbed by the vibration absorption member 81, and thus the detection of the decrease in ink of the pressure sensor chamber 33D can be reliably performed.

Specifically, as the liquid amount in the pressure sensor chamber 33D decreases, a frequency of an output waveform of the piezoelectric element 44 at a predetermined place in a region (the region Q in FIG. 19) where the vibration absorption member 81 is extremely close to the piezoelectric sensor 34 is set a threshold value, and, at a time that exceeds the threshold value, it is judged that the ink amount in the pressure sensor chamber 33D decreases.

That is, when there is a space that can ensure a sufficient distance between the piezoelectric sensor 34 and the vibration absorption member 81, the detection of the decrease in liquid amount of the pressure sensor chamber 33D can be rapidly and reliably performed on the basis of the output signal from the piezoelectric element 44 when the vibration absorption member 81 is closed to the piezoelectric sensor 34.

In contrast, when the sufficient distance between the piezoelectric sensor 34 and the vibration absorption member 81 cannot be ensured, preferably, the detection of the decrease in liquid amount of the pressure sensor chamber 33D is performed on the basis of an output signal from the piezoelectric element 44 when the vibration absorption member 81 comes into contact with the piezoelectric sensor 34.

Moreover, in the above-described embodiment, a case where the liquid detection apparatus 30D is applied to the ink cartridge 100 of the recording apparatus has been described. However, the invention is not limited to the ink cartridge 100 of the recording apparatus. For example, the liquid detection apparatus 30D can be applied to a printing apparatus or a microdispenser, in addition to the recording apparatus. Further, the liquid detection apparatus 30D may be directly provided in the flow passage of the liquid or the like of the above apparatuses.

In the above-described embodiment, the plate-shaped vibration absorption member 81 is used, but the vibration absorption member 81 may have a film shape.

In the above-described embodiment, the vibration absorption member 81 is displaced by the deformation of the support film 80 according to the decrease in ink amount of the pressure sensor chamber 33D. Alternatively, the vibration absorption member 81 may be urged toward the piezoelectric sensor 34 by an urging member, such as a spring or the like, having an urging force weaker than the liquid pressure in the pressure sensor chamber 33D, thereby making sure the displacement of the vibration absorption member 81 when the ink amount in the pressure sensor chamber 33D decreases.

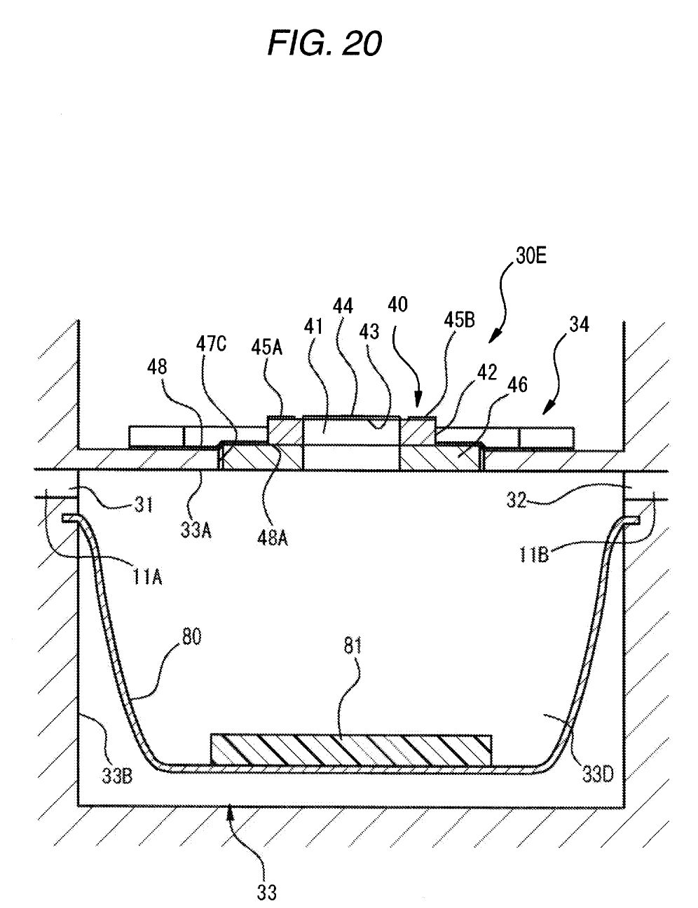

Moreover, the liquid detection apparatus may be simplified than the liquid detection apparatuses of the above-described embodiments. For example, the flow passages 46A and 47A shown in FIGS. 15, 17, and 18 may be omitted, as shown in FIG. 20. Referring to FIG. 20, in a liquid detection apparatus 30E, a sensor cavity 41 directly faces a pressure sensor chamber 33D. With this configuration, ink can be easily filled in the sensor cavity 41 compared with a case where the flow passages 46A and 47A are provided.

1. A liquid detection apparatus for detecting a liquid amount in a liquid container, comprising:
a sensor chamber for introducing liquid to be delivered from a liquid containing portion and supplying the liquid externally;
a diaphragm that defines a part of the sensor chamber and is movable in response to a liquid containing amount in the sensor chamber;
a pressure receiving plate that is attached to the diaphragm;
a recess portion that is connected to the sensor chamber and is closed by the pressure receiving plate when the liquid containing amount in the sensor chamber becomes not more than a predetermined amount;
a piezoelectric element that applies vibration to at least a part of the recess portion so as to detect a free vibration state according to the applied vibration;
a detection portion that detects at least one of an amplitude value and a frequency of a residual vibration waveform of a counter electromotive force by the free vibration state detected by the piezoelectric element; and
a calculation portion that calculates the liquid residual amount in the liquid container based on at least one of the amplitude value and the frequency of the residual vibration waveform detected by the detection portion.

2. A liquid detection apparatus for detecting a liquid amount in a liquid container, comprising:
a sensor chamber for introducing liquid to be delivered from a liquid containing portion and supplying the liquid externally;
a diaphragm that defines a part of the sensor chamber and is movable in response to a liquid containing amount in the sensor chamber;
a recess portion that is connected to the sensor chamber and is displaced together with the diaphragm so as to be closed by a bottom inner surface of the sensor chamber when the liquid containing amount in the sensor chamber becomes not more than a predetermined amount;
a piezoelectric element that is attached to the diaphragm and applies vibration to at least a part of the recess portion so as to detect a free vibration state according to the applied vibration;
a detection portion that detects an amplitude value or frequency of a residual vibration waveform of a counter electromotive force by the free vibration state detected by the piezoelectric element; and
a calculation portion that calculates the liquid amount in the liquid container based on at least one of the amplitude value and the frequency of the residual vibration waveform detected by the detection portion.

3. The liquid detection apparatus according to claim 1, further comprising:
a pressure adjusting member that is attached so as to cause the diaphragm to be displaced at a predetermined pressure.

4. The liquid detection apparatus according to claim 1,
wherein the diaphragm is a flexible film.

5. The liquid detection apparatus according to claim 1,
wherein the diaphragm is a thin plate member on which aluminum is laminated.

6. The liquid detection apparatus according to claim 1,
wherein the liquid is ink.

7. A liquid detection apparatus for detecting a liquid amount in a liquid container, comprising:
a pressure sensor chamber that has a liquid inlet port connected to a liquid containing portion storing liquid and a liquid outlet port for supplying the liquid externally;
a liquid detecting unit that has a vibrating plate, a cavity being formed on a side of the pressure sensor chamber of the vibrating plate;
a piezoelectric element that is attached to the vibrating plate of the liquid detecting unit and applies vibration to the vibrating plate so as to detect a free vibration state according to the vibration; and
a flexible diaphragm that displaceably supports the liquid detecting unit according to a liquid amount in the pressure sensor chamber and forms a part of the pressure sensor chamber together with the liquid detecting unit.

8. The liquid detection apparatus according to claim 7, further comprising:
an urging member that urges the liquid detecting unit toward a wall surface forming the pressure sensor chamber,
wherein the liquid detecting unit comes into contact with the wall surface by an urging force of the urging member according to a decrease of the liquid amount in the pressure sensor chamber so as to close the cavity.

9. The liquid detection apparatus according to claim 8,
wherein the urging member has an urging force weaker than a liquid pressure of the liquid flowing into the pressure sensor chamber.

10. The liquid detection apparatus according to claim 7,
wherein the diaphragm is formed of an aluminum-laminated film on which aluminum is laminated.

11. A liquid detection apparatus for detecting a liquid amount in a liquid container, comprising:
a pressure sensor chamber that has a liquid inlet port connected to an external liquid containing portion storing liquid and a liquid outlet port for supplying the liquid externally;
a liquid detecting unit that has a vibrating plate, a cavity being formed on a side of the pressure sensor chamber of the vibrating plate;
a piezoelectric element that is attached to the vibrating plate of the liquid detecting unit and applies vibration to the vibrating plate so as to detect a free vibration state according to the vibration; and
a vibration absorption member that is formed of an elastic material,
wherein the liquid detecting unit and the vibration absorption member are disposed to be relatively displaced in a direction close to each other and distant from each other according to a liquid amount in the pressure sensor chamber.

12. The liquid detection apparatus according to claim 11,
wherein, as the liquid amount in the pressure sensor chamber decreases, the decrease of the liquid amount in the pressure sensor chamber is detected based on an output signal from the piezoelectric element when the vibration absorption member comes into contact with the liquid detecting unit.

13. The liquid detection apparatus according to claim 11,
wherein, as the liquid amount in the pressure sensor chamber decreases, the decrease of the liquid amount in the pressure sensor chamber is detected based on an output signal from the piezoelectric element when the vibration absorption member is close to the liquid detecting unit.

14. The liquid detection apparatus according to claim 11,
wherein the vibration absorption member is supported by a flexible film that forms a portion of the pressure sensor chamber, and
when the film is deformed by the liquid amount in the pressure sensor chamber, the vibration absorption member is displaced in a direction close to and distant from the liquid detecting unit.

15. A liquid container comprising:
a liquid containing portion that is pressurized by a pressure unit so as to deliver liquid;
a liquid supply port that is connected to the liquid containing portion so as to supply the liquid externally;
a sensor chamber for introducing the liquid delivered from the liquid containing portion and delivering the liquid to the liquid supply port;
a diaphragm that defines a part of the sensor chamber and is movable in response to a liquid containing amount in the sensor chamber;
a pressure receiving plate that is attached to the diaphragm;
a recess portion that is connected to the sensor chamber and is closed by the pressure receiving plate when the liquid containing amount in the sensor chamber becomes not more than a predetermined amount; and
a piezoelectric element that applies vibration to at least a part of the recess portion so as to detect a free vibration state according to the applied vibration.

16. The liquid detection apparatus according to claim 2, further comprising:
a pressure adjusting member that is attached so as to cause the diaphragm to be displaced at a predetermined pressure.

17. The liquid detection apparatus according to claim 2,
wherein the diaphragm is a flexible film.

18. The liquid detection apparatus according to claim 2,
wherein the diaphragm is a thin plate member on which aluminum is laminated.

19. The liquid detection apparatus according to claim 2,
wherein the liquid is ink.

20. A liquid container comprising:
a liquid containing portion that is pressurized by a pressure unit so as to deliver liquid;
a liquid supply port that is connected to the liquid containing portion so as to supply the liquid externally;
a sensor chamber for introducing the liquid delivered from the liquid containing portion and delivering the liquid to the liquid supply port;
a diaphragm that defines a part of the sensor chamber and is movable in response to a liquid containing amount in the sensor chamber;
a recess portion that is connected to the sensor chamber and is displaced together with the diaphragm so as to be closed by a bottom inner surface of the sensor chamber when the liquid containing amount in the sensor chamber becomes not more than a predetermined amount; and
a piezoelectric element that is attached to the diaphragm and applies vibration to at least a part of the recess portion so as to detect a free vibration state according to the applied vibration.

21. A liquid container comprising:
a liquid containing portion that is pressurized by a pressure unit so as to deliver liquid;
a liquid supply port that is connected to the liquid containing portion so as to supply the liquid externally;
a pressure sensor chamber that has a liquid inlet port connected to the liquid containing portion and a liquid outlet port connected to the liquid supply port;
a liquid detecting unit that has a vibrating plate, a cavity being formed on a side of the pressure sensor chamber of the vibrating plate;
a piezoelectric element that is attached to the vibrating plate of the liquid detecting unit and applies vibration to the vibrating plate so as to detect a free vibration state according to the vibration; and
a flexible diaphragm that displaceably supports the liquid detecting unit according to a liquid amount in the pressure sensor chamber and forms a part of the pressure sensor chamber together with the liquid detecting unit.

22. A liquid container comprising:
a liquid containing portion that is pressurized by a pressure unit so as to deliver liquid;
a liquid supply port that is connected to the liquid containing portion so as to supply the liquid externally;
a pressure sensor chamber that has a liquid inlet port connected to the liquid containing portion and a liquid outlet port connected to the liquid supply port;
a liquid detecting unit that has a vibrating plate, a cavity being formed on a side of the pressure sensor chamber of the vibrating plate;
a piezoelectric element that is attached to the vibrating plate of the liquid detecting unit and applies vibration to the vibrating plate so as to detect a free vibration state according to the vibration; and
a vibration absorption member that is formed of an elastic material,
wherein the liquid detecting unit and the vibration absorption member are disposed to be relatively displaced in a direction close to each other and distant from each other according to a liquid amount in the pressure sensor chamber.

23. A liquid container comprising:
a liquid containing portion containing liquid therein;
a liquid supply port for supplying the liquid externally; and
a sensor chamber that has a liquid inlet port connected to the liquid containing portion, a liquid outlet port connected to the liquid supply port, and a cavity;
a liquid detecting unit that has a vibrating plate, the vibrating plate facing toward the cavity of the sensor chamber;
a piezoelectric element that is attached to the vibrating plate of the liquid detecting unit to apply vibration to the vibrating plate so as to detect a free vibration state according to the vibration; and
a flexible diaphragm that displaceably supports the liquid detecting unit according to an amount of liquid in the sensor chamber and defines a part of the sensor chamber together with the liquid detecting unit.

24. A liquid container comprising:
a liquid containing portion containing liquid therein;
a liquid supply port for supplying the liquid externally;
a sensor chamber that has a liquid inlet port connected to the liquid containing portion, a liquid outlet port connected to the liquid supply port, and a cavity;
a liquid detecting unit that has a vibrating plate, the vibrating plate facing toward the cavity of the sensor chamber;
a piezoelectric element that is attached to the vibrating plate of the liquid detecting unit and applies vibration to the vibrating plate so as to detect a free vibration state according to the vibration; and
a vibration absorption member that is formed at least in part from an elastic material,
wherein the liquid detecting unit and the vibration absorption member are arranged so that a distance between the liquid detecting unit and the vibration absorption member is varied according to an amount of liquid in the sensor chamber.
